(19) United States
(12) Patent Application Publication
(10) Pub. No.: US 2026/0287119 A1
(43) Pub. Date: Sep. 24, 2026

(54) HYDROGEN FUELING MODULE

(71) Applicants: Robert Bosch GmbH, Stuttgart (DE); FirstElement Fuel Inc., Irvine, CA (US); Bosch Rexroth Corporation, Mt. Prospect, IL (US)

(72) Inventors: Tim Brown, San Juan Capistrano, CA (US); Ghassan Sleiman, Torrance, CA (US); Joshua Adams, Aliso Viejo, CA (US); Tyler Furuya, Westminster, CA (US); Royce Gerngross, Cypress, TX (US); Ralf Maier, Neuendorf/Main (DE); Stephan Becker, Haibach (DE); Stefan-Georg Backhaus, Partenstein (DE); Andreas Guender, Ramsthal (DE); James S. Lane, Coplay, PA (US); Sophia Lynn Zaikos, Northampton, PA (US); Scott Vander Veen, Port Colborne (CA); Konrad Hartmann, Rechtenbach (DE); Robert Paul Eddleman, Duarte, CA (US)

(21) Appl. No.: 19/569,994

(22) Filed: Mar. 17, 2026

Related U.S. Application Data
(60) Provisional application No. 63/774,094, filed on Mar. 18, 2025.

(51) Int. Cl. F17C 5/00

(52) U.S. Cl. CPC F17C 5/007; F17C 2221/012; F17C 2227/0142; F17C 2250/0452; F17C 2265/065; F17C 2270/0168

(57) ABSTRACT

A containerized hydrogen pumping module includes a base portion, and a component portion housing. The component portion housing includes an electronics compartment housing, a hydraulic compartment housing, and a hydrogen compartment housing. A main shipping assembly includes the base portion, the electronics compartment housing, the hydraulic compartment housing, and at least a portion of the hydrogen compartment housing. The main shipping assembly is configured to, in an assembled state, not exceed outer dimensions of a high-cube container.

This application claims benefit to provisional Application No. 63/774,094, filed on Mar. 18, 2025, the disclosure of which is incorporated herein by reference in its entirety.

### FIELD

The present disclosure relates generally to hydrogen pumping stations, and more particularly to a hydrogen pumping module.

### BACKGROUND

Hydrogen has shown promise as an alternative power source for vehicles and other transportation applications. Fuel cells are one application of hydrogen. Fuel cells based on hydrogen operate without toxic emissions and greenhouse gases. In order to resupply a vehicle which uses hydrogen as the renewable energy carrier hydrogen is stored, typically in a fluid form, at a hydrogen pumping system which, when used to provide fuel for a vehicle, is also called a hydrogen fueling station.

Hydrogen fueling stations for vehicles can store bulk hydrogen as a liquid at a pressure of 1 to 6 barg and a temperature of 18 to 25 K. (Note: “barg” refers to gage pressure in units of bar). In order to dispense the stored liquid hydrogen to hydrogen-fueled vehicles, the hydrogen is typically provided in a super critical state at a high pressure of 600 to 1000 barg and a temperature of −40 to −20 deg C. (233 to 253 K).

In other applications, hydrogen fueling stations are configured to provide liquid hydrogen at substantially lower pressures. These stations, referred to as “subcooled liquid hydrogen or “sLH2” fueling stations provide liquid fuel to vehicles at about 0.4 MPa to 2.0 MPa, and typically between 0.6 MPa and 1.4 MPa.

As is evident from the foregoing, specialized equipment is required at hydrogen refueling stations. Moreover, since the use of cryogenic hydrogen as a fuel for vehicles is an emerging market, the infrastructure to support refueling of hydrogen powered vehicles has not fully developed. Because of the specialized nature of the equipment, building the required infrastructure is difficult. For example, building a system in situ can create delays due to weather related issues, and personnel availability.

The difficulties in providing the requisite infrastructure to support the supply of hydrogen are increased due to regulation of the components in the refueling station. The regulations are generated because hydrogen is a volatile substance which, if not properly handled, can combust in an uncontrolled manner. Consequently, a number of local codes have been produced which address safety issues not only of the components within a refueling system, but of the refueling system as a whole.

The foregoing issues have contributed to difficulty in providing the infrastructure needed to support, for example, nationwide use of hydrogen fuel in vehicles. Consequently, hydrogen fuel has been introduced into limited markets. This renders the hydrogen vehicles virtually useless when an individual wants to travel outside of a supported area.

What is needed is a system which addresses one or more of the foregoing issues. It would be beneficial if a system or at least a significant part of a system could be assembled or at least substantially assembled in a controlled environment, and easily transported to a different location for final assembly.

### SUMMARY

According to one embodiment of the present disclosure, a containerized hydrogen pumping module includes a base portion, and a component portion housing, the component portion housing including an electronics compartment housing, a hydraulic compartment housing, and a hydrogen compartment housing. A main shipping assembly includes the base portion, the electronics compartment housing, the hydraulic compartment housing, and at least a portion of the hydrogen compartment housing, and the main shipping assembly is configured in an assembled state to not exceed outer dimensions of a high-cube container.

In one or more embodiments, the hydraulic compartment housing includes a main hydrogen compartment housing and a hydrogen compartment cap housing positioned above the main hydrogen compartment housing. The main shipping assembly includes the main hydrogen compartment housing. The main shipping assembly does not include the hydrogen compartment cap housing, and a height of the main hydrogen compartment housing and the hydrogen compartment cap housing is greater than a height of the high-cube container when assembled in the containerized hydrogen pumping module.

In one or more embodiments a hydrogen compartment is defined at least in part by the hydrogen compartment housing and a hydraulic compartment is defined at least in part by the hydraulic compartment housing. A first internal wall is configured to seal the hydrogen compartment from the hydraulic compartment in the assembled state.

In one or more embodiments, an electronics compartment is defined at least in part by the electronics compartment housing and a second internal wall is located between the electronics compartment and the hydraulic compartment. The hydraulic compartment defines at least in part a first ventilation path between a first external vent and at least one blower. The hydrogen compartment defines at least in part a second ventilation path between a second external vent and the at least one blower. The first ventilation path extends from a lower portion of the hydraulic compartment to an upper portion of the hydraulic compartment. The second ventilation path extends from a lower portion of the hydrogen compartment to an upper portion of the hydrogen compartment. The at least one blower is configured to move air along the first ventilation path and along the second ventilation path.

In one or more embodiments the at least one blower includes a first blower configured to move air along the first ventilation path, and a second blower configured to move air along the second ventilation path.

In one or more embodiments an electronics compartment is defined at least in part by the electronics compartment housing. A second internal wall is located between the electronics compartment and the hydraulic compartment. The hydrogen compartment and the hydraulic compartment define at least in part a ventilation path. The ventilation path extends from a lower portion of the hydraulic compartment to an upper portion of the hydraulic compartment, the ventilation path extends from the upper portion of the hydraulic compartment through the first internal wall to a lower portion of the hydrogen compartment, the ventilation path extends from the lower portion of the hydrogen compartment to an upper portion of the hydrogen compartment, and a blower is configured to move air along the ventilation path. In some embodiments, the ventilation path extends through and/or beneath the electronics compartment.

In one or more embodiments the containerized hydrogen pumping module includes a first hydrogen sensor positioned in the upper portion of the hydraulic compartment and a second hydrogen sensor positioned at the upper portion of the hydrogen compartment, and is provided with a main power switch through which all electrical power to the containerized hydrogen pumping module is provided, a memory having program instructions stored therein, and a controller operably connected to the first hydrogen sensor, the second hydrogen sensor, the main power switch, and the memory. The controller is configured to execute the program instructions to activate the ventilation system, including activation of any associated blowers, in response to detection of hydrogen above a threshold by at least one of the hydrogen sensors. The hydrogen compartment and hydraulic compartments are sealed externally with the exception of the ventilation path in some embodiments, or at least partially sealed, to ensure movement of hydrogen along the ventilation path. If the sensed level of hydrogen does not decrease in response to activation of the ventilation system within a predetermined time from activation, or continues to rise, the controller is configured to deactivate all equipment which is not rated for operation in a hazardous area such as a National Electric Code compartment classified as a Class 1, Division 2 Group B compartment. For embodiments including a hydrogen sensor in the electronics compartment, the controller in some embodiments is configured to remove all power to the containerized hydrogen pumping module upon sensing of hydrogen above a predetermined level.

In one or more embodiments the containerized hydrogen pumping module includes a backup power supply, the backup power supply configured to power the blower when the controller opens the main power switch in response to the hydrogen level which exceeds the predetermined threshold. In some embodiments no back-up power is used so as to remove all power from the system in case of high levels of hydrogen.

In one or more embodiments the base portion includes a base support component, and a polymer concrete support structure supported by the base support component.

In one or more embodiments the containerized hydrogen pumping module includes a plurality of sound isolation components, wherein the polymer concrete support structure is supported on the base support component by the plurality of sound isolation components.

In one or more embodiments the containerized hydrogen pumping module includes a hydraulic support assembly mounted on the polymer concrete support structure and extending upwardly within a hydraulic compartment defined at least in part by the hydraulic compartment housing, a main hydraulic system manifold mounted on an upper surface of the hydraulic support assembly, and a hydraulic supply system fluidically connected to at least one low-pressure pump of a low-pressure pump system, and at least one second stage pump of a second stage pump system. The hydraulic supply system is supported within the hydraulic compartment solely through the main hydraulic system manifold.

In one or more embodiments the containerized hydrogen pumping module includes a second stage support assembly mounted on the polymer concrete support structure and extending upwardly within a hydrogen compartment defined at least in part by the hydrogen compartment housing, wherein the second stage pump system is supported within the hydrogen compartment solely through the second stage support assembly.

In one or more embodiments the containerized hydrogen pumping module includes a base member fixedly mounted on the polymer concrete support structure, an adjustable support plate mounted on the base member with a plurality of adjusting bolts, the plurality of adjusting bolts configured to modify an orientation of the adjustable support plate with the base member. The second stage pump system is supported by the base member through the adjustable support plate.

In one or more embodiments the containerized hydrogen pumping module includes a first internal wall configured to seal the hydrogen compartment from the hydraulic compartment in the assembled state, wherein the main hydraulic system manifold extends through the first internal wall to the hydrogen compartment, and all hydraulics to the hydrogen compartment are supplied through the main hydraulic system manifold.

### BRIEF DESCRIPTION OF THE DRAWINGS

The above-described features and advantages, as well as others, will become more readily apparent to those of ordinary skill in the art by reference to the following detailed description and accompanying drawings.

FIG. 1 depicts a simplified schematic depiction of a hydrogen pumping system that is used to provide hydrogen to a vehicle or to transfer hydrogen from one reservoir or tank to another reservoir or tank;

FIG. 2 depicts a side perspective view of the containerized hydrogen pumping module of FIG. 1;

FIG. 3 depicts a side plan view of the containerized hydrogen pumping module of FIG. 1;

FIG. 4 depicts a side perspective view of the component portion housing of FIG. 1 in which only framing and interior walls are shown;

FIG. 5 depicts a side plan view of the component portion housing of FIG. 1 in which only framing and interior walls are shown;

FIG. 6 depicts a side perspective view of the containerized hydrogen pumping module of FIG. 2 with components removed to show a main shipping assembly;

FIG. 7 depicts a side perspective view of a minimum form of the main shipping assembly;

FIG. 8 depicts a top perspective view of a structural frame of the containerized hydrogen pumping module;

FIG. 9 depicts a side perspective view of dampers used in the containerized hydrogen pumping module;

FIG. 10 depicts a top perspective view the dampers of FIG. 9 incorporated into the structural frame of the containerized hydrogen pumping module;

FIG. 11 depicts a top perspective view of a polymer concrete support assembly positioned on the structural frame;

FIG. 12 depicts a top perspective view of a structural frame of the polymer concrete support assembly of FIG. 11;

FIG. 13 depicts a top perspective view of the polymer concrete support assembly of FIG. 11;

FIG. 14 depicts a bottom perspective view of the polymer concrete support assembly of FIG. 11;

FIG. 15 depicts a top perspective view of a hydraulic plant mounted on the polymer concrete support assembly;

FIG. 16 depicts a top perspective view of a hydraulic support assembly mounted on the polymer concrete support assembly;

FIG. 17 depicts a side perspective view of a first side of a main hydraulic manifold mounted on the hydraulic support assembly;

FIG. 18 depicts a side perspective view of a second side of the main hydraulic manifold mounted on the hydraulic support assembly;

FIG. 19 depicts a partial side perspective view of the second side of the main hydraulic manifold showing mounting holes, hydraulic conduits, and mounting pins;

FIG. 20 depicts a side perspective view of the hydraulic plant with components mounted on the upper support face;

FIG. 21 depicts a front perspective view of the main hydraulic manifold with components mounted on the first main support face and the second main support face;

FIG. 22 depicts aside plan view of various auxiliary system components mounted on the main hydraulic manifold and mounted on the auxiliary support lip of the hydraulic support assembly;

FIG. 23 depicts a side plan view of one side of the main hydraulic manifold with components mounted thereto;

FIG. 24 depicts a side plan view of the side opposite the side of FIG. 23 of the main hydraulic manifold with components mounted thereto;

FIG. 25 depicts a side plan view of one side of the main hydraulic manifold with components mounted thereto;

FIG. 26 depicts a side plan view of the side opposite the side of FIG. 25 of the main hydraulic manifold with components mounted thereto;

FIG. 27 depicts a side plan view of the component portion housing showing components within the hydrogen compartment which extend into the hydrogen compartment cap portion;

FIG. 28 depicts a side plan view of the component portion housing showing components within the hydrogen compartment which extend into the hydrogen compartment cap portion removed and with the hydrogen compartment cap portion removed;

FIG. 29 depicts a top perspective view of a base member positioned on a secondary pump support frame;

FIG. 30 depicts a top perspective view of a threaded hole of the base member;

FIG. 31 depicts a side plan view of a screw and nut used with the base member;

FIG. 32 depicts a top perspective view of the screws positioned within the holes of the base member;

FIG. 33 depicts a bottom perspective view of an adjustable support plate which is adjusted by the screws;

FIG. 34 depicts an enlarged portion of the adjustable support plate of FIG. 33;

FIG. 35 depicts a side plan view of the adjustable support plate supported by the screws and the base member;

FIG. 36 depicts an end plan view of the adjustable support plate supported by the screws and the base member;

FIG. 37 depicts a top perspective view of secondary pump mounts positioned in the adjustable support plate;

FIG. 38 depicts an end plan view of secondary pump mounts positioned in the adjustable support plate;

FIG. 39 depicts a top perspective view of the warm end portion of s secondary pump mounted to the adjustable support plate;

FIG. 40 depicts a top perspective view of a first sub-manifold mounted to the main hydraulic manifold;

FIG. 41 depicts a top perspective view of conduits within the warm end portion with the housing of the removed;

FIG. 42 depicts a top perspective view of a manifold mounting face of the warm end portion;

FIG. 43 depicts a top perspective view of a second sub-manifold mounted to the warm end portion;

FIG. 44 depicts a top perspective view of a second warm end portion mounted on the adjustable support plate and attached to the second sub-manifold;

FIG. 45A depicts a side perspective view of the intermediate portions of two second stage pumps mounted to the warm end portions which are mounted on the adjustable support plate;

FIG. 45B depicts a side perspective view of the intermediate portions of two second stage pumps mounted to the warm end portions which are mounted on the adjustable support plate, along with the vacuum jacketed sump, the intermediate portion, and the intermediate portion mounted to the structural frame;

FIG. 46 depicts a side perspective view of an electrical component assembly mounted on the structural frame 250;

FIG. 47 depicts a side perspective view of the main support panel of the electrical component assembly of FIG. 46;

FIG. 48 depicts a side perspective view of the side opposite the side shown in FIG. 47 of the main support panel of the electrical component assembly of FIG. 46;

FIG. 49 depicts the auxiliary support panel of the electrical component assembly;

FIG. 50 depicts a side perspective view of the component portion housing divided in two frame sub-assemblies;

FIG. 51 depicts a top perspective view of one of the frame sub-assemblies of FIG. 50 positioned on the structural frame with components mounted in the electronics compartment, the hydraulic compartment, and the hydrogen compartment;

FIG. 52 depicts a top perspective view of both of the frame sub-assemblies of FIG. 50 positioned on the structural frame with components mounted in the electronics compartment, the hydraulic compartment, and the hydrogen compartment;

FIG. 53 depicts a top perspective view of one of the frame sub-assemblies of FIG. 50 positioned on the structural frame with no components mounted in the electronics compartment, the hydraulic compartment, or the hydrogen compartment;

FIG. 54 depicts a top perspective view of both of the frame sub-assemblies of FIG. 50 positioned on the structural frame with no components mounted in the electronics compartment, the hydraulic compartment, or the hydrogen compartment;

FIG. 55 depicts a side plan view of the component portion housing with various components mounted to the component portion housing;

FIG. 56 depicts a top perspective view of the component portion housing with various components mounted to the component portion housing;

FIG. 57 depicts a side perspective view of an internal wall;

FIG. 58 depicts a side perspective view of the opposite side of the internal wall of FIG. 57;

FIG. 59 depicts a side perspective view of the opposite side of the internal wall of FIG. 57 with panels removed;

FIG. 60 depicts a side perspective view of the internal wall of FIG. 57 positioned with the main hydraulic manifold extending through a manifold opening of the internal wall and the polymer concrete support assembly extending through the polymer concrete support assembly opening of the internal wall;

FIG. 61 depicts a side perspective view of another internal wall;

FIG. 62 depicts a partial bottom perspective view of the containerized hydrogen pumping module with some components removed to show a ceiling portion of the hydraulic compartment;

FIG. 63 depicts a top perspective view of the hydraulic compartment showing a vent positioned near the ceiling of the hydraulic compartment;

FIG. 64 depicts a side perspective view of the containerized hydrogen pumping module showing a ventilation conduit in the hydraulic compartment and a ventilation conduit in the hydrogen compartment;

FIG. 65 depicts a top perspective view of a blower positioned on the hydrogen compartment cap portion;

FIG. 66A depicts a side perspective view of vents alternatively positioned in the hydrogen compartment and the hydraulic compartment;

FIG. 66B depicts a side perspective view of vents alternatively positioned in the structural frame 250;

FIG. 67 depicts side perspective views of sides of a door of the containerized hydrogen pumping module;

FIG. 68 depicts a side perspective view of the door of FIG. 67 with insulation and an inner side panel of the door removed;

FIG. 69 depicts a side perspective view of the door of FIG. 67 with insulation installed and an inner side panel of the door removed;

FIG. 70 depicts a side perspective view of the opposite sides of a panel of the containerized hydrogen pumping module;

FIG. 71 shows a side perspective view of the main shipping assembly;

FIG. 72 shows a side perspective view of the opposite side shown in FIG. 71 of the main shipping assembly;

FIG. 73 depicts a flow chart of a process of assembling the containerized hydrogen pumping module and assembling the containerized hydrogen pumping module into the hydrogen pumping system;

FIG. 74 depicts a side plan view of the containerized hydrogen pumping module with number of guide brackets to facilitate positioning of guard posts;

FIG. 75 depicts a side plan view of the containerized hydrogen pumping module of FIG. 74 with guard posts installed;

FIG. 76 depicts a side plan view of a guide used with the guide brackets of FIG. 74;

FIG. 77 depicts a top plan view of the guide of FIG. 76;

FIG. 78 depicts a schematic view of a containerized hydrogen pumping module control system for the containerized hydrogen pumping module of FIG. 2;

FIG. 79 depicts a flow chart of a process for controlling ventilation within the containerized hydrogen pumping module; and

FIG. 80 depicts a side perspective view of an alternative containerized hydrogen pumping module provided with hydrogen compressors.

### DETAILED DESCRIPTION

For the purpose of promoting an understanding of the principles of the disclosure, reference will now be made to the embodiments illustrated in the drawings and described in the following written description. It is to be understood that no limitation to the scope of the disclosure is thereby intended. It is further to be understood that the present disclosure includes any alterations and modifications to the illustrated embodiments and includes further applications of the principles of the disclosure as would normally occur to one skilled in the art to which this disclosure pertains.

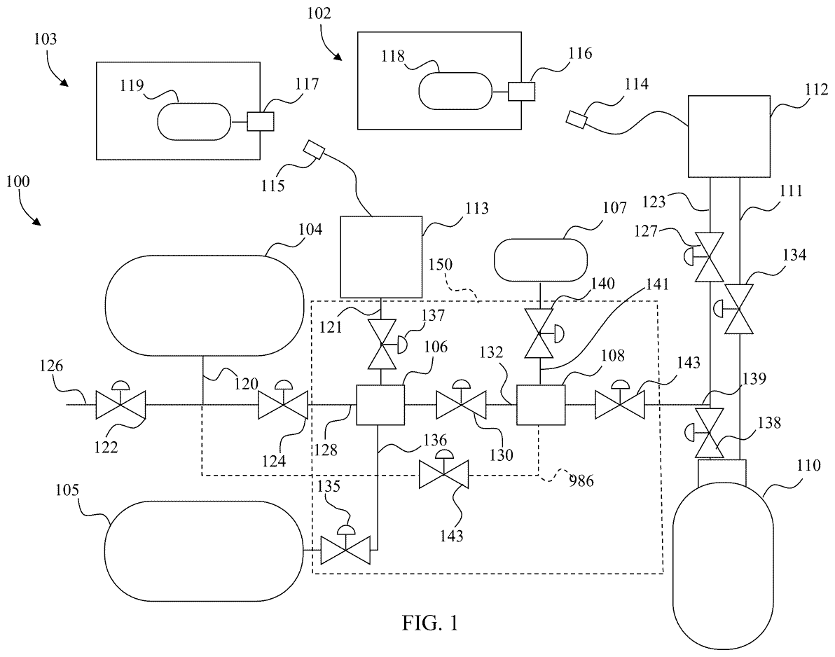

FIG. 1 is a simplified schematic depiction of a hydrogen pumping system 100 which in one embodiment is configured in part as a hydrogen pumping station to provide hydrogen to a vehicle 102, a vehicle 103, a bulk storage tank 105, and/or a bulk storage tank 107. The hydrogen pumping system 100 in some embodiments is configured to handle cryogenic hydrogen. The hydrogen pumping system 100 includes a bulk storage tank 104, a low-pressure pump system 106, a second stage pump system 108, a ready storage tank 110, and a dispensing unit 112 fluidly connected to the ready storage tank 110 through a supply line 111. The dispensing unit 112 includes a nozzle 114 which is used to couple with a receiver 116 of the vehicle 102 to fill a hydrogen tank 118 of the vehicle 102.

The hydrogen pumping system 100 further includes an sLH2 pumping system with a dispensing unit 113 including a nozzle 115 which is used to couple with a receiver 117 of a vehicle 103 to fill a hydrogen tank 119 of the vehicle 103. The vehicle 103 in various embodiments is a motorcycle, a passenger vehicle, a truck, a heavy-duty truck, a train, a boat or ferry, an aircraft, or any desired vehicle. The low-pressure pump system 106 is in fluid connection with the dispensing unit 113 through a supply line 121. The second stage pump system 108 in some embodiments is directly connected to the dispensing unit 112 through a supply line 123.

In some embodiments, one or more of the bulk storage tank 105, the bulk storage tank 107, the dispensing unit 112, the dispensing unit 113, and the ready storage tank 110 is/are omitted from the hydrogen pumping system 100. By way of example, in one embodiment the hydrogen pumping system omits the bulk storage tank 105 and/or the bulk storage tank 107 and is configured to provide hydrogen to vehicles at high pressure and/or low pressure (sLH2). In some embodiments only the low-pressure pump system 106 is used. Some of the systems in different embodiments are configured to provide hydrogen to the dispensing unit 113 and/or the bulk storage tank 105. In some systems higher pressure hydrogen is provided only to the bulk storage tank 107, and the ready storage tank 110 and dispensing unit 112 are omitted. In some embodiments the second stage pump system 108 only supplies the dispensing unit 112.

Continuing with FIG. 1, the bulk storage tank 104 in one embodiment is configured to store liquid hydrogen at a pressure of 0 to 6 barg and a temperature of 18 to 25° K. The bulk storage tank 104 includes at least one port 120 which is used to supply liquid hydrogen to, and/or provide liquid hydrogen from, the bulk storage tank 104. Isolation valves 122 and 124 are used to selectively connect the port 120 to a supply line 126 or an input header 128 of the low-pressure pump system 106. In some embodiments the bulk storage tank 105 is configured similarly to the bulk storage tank 104.

Another isolation valve 130 is provided on the second stage supply header 132 between the low-pressure pump system 106 and the second stage pump system 108. Isolation valve 134 is provided on the supply line 111 between the ready storage tank 110 and the dispensing unit 112. Isolation valve 135 is provided on a supply line 136 between the low-pressure pump system 106 and the bulk storage tank 105. Isolation valve 137 is provided on the supply line 121 between the low-pressure pump system 106 and the dispensing unit 113. Isolation valve 138 is provided on the line 139 between the second stage pump system 108 and the ready storage tank 110. Isolation valve 127 is provided on the supply line 123 between the second stage pump system 108 and the dispensing unit 112. Isolation valve 140 is located on the supply line 141 between the second stage pump system 108 and the bulk storage tank 107. More or fewer valves, such as outlet valve 143, may be incorporated into the system as desired for a particular configuration.

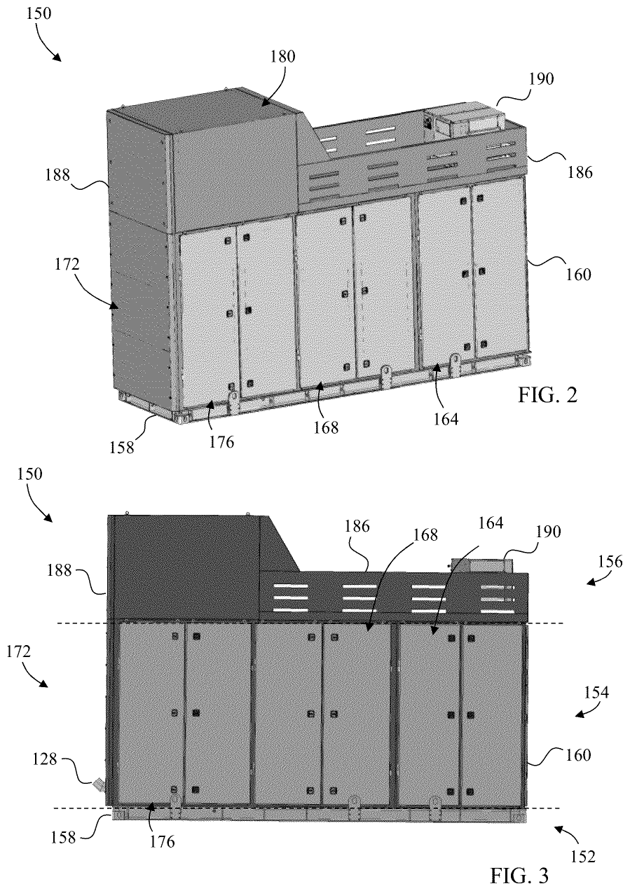

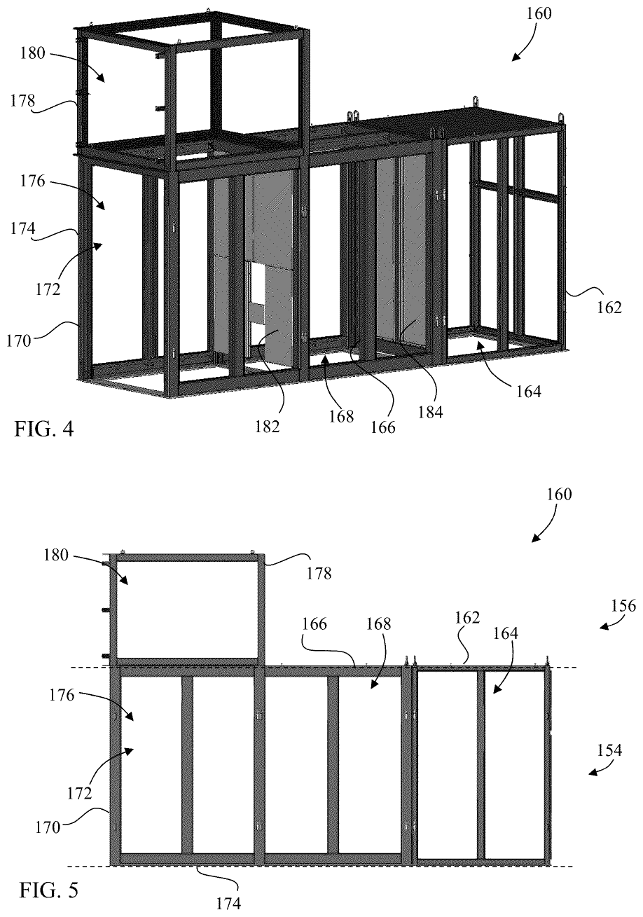

A number of components in the hydrogen pumping system 100 are provided in a containerized hydrogen pumping module 150 also shown in FIGS. 2 and 3. The containerized hydrogen pumping module 150 includes a support region 152, a main region 154, and a canopy region 156. The support region 152 primarily includes a part of a base portion 158. The main region 154 includes a component portion housing 160 which is shown in further detail in FIGS. 4 and 5 in which only framing and interior walls are shown.

The component portion housing 160 includes electronics compartment framing 162 which sets the boundaries of an electronics compartment 164. The component portion housing 160 further includes hydraulic compartment framing 166 which sets the boundaries of a hydraulic compartment 168. Additionally, the component portion housing 160 includes hydraulic compartment framing 170 which sets the boundaries of a hydrogen compartment 172. The hydraulic compartment framing 170 includes a main hydrogen framing 174 which sets the boundaries of a main hydrogen compartment portion 176, and a hydrogen compartment cap framing 178 which sets the boundaries of a hydrogen compartment cap portion 180. The hydrogen compartment 172 is separated from the hydraulic compartment 168 by a wall 182 which is discussed in further detail below. The hydraulic compartment 168 is separated from the electronics compartment 164 by a wall 184. As shown in FIG. 5, all of the framing is located within the main region 154 with the exception of the hydrogen compartment cap framing 178.

Returning to FIGS. 2 and 3, the input header 128 (not shown in FIG. 2) extends outwardly of the main hydrogen compartment portion 176. Additionally, a protective railing assembly 186 is located within the canopy region 156 along with a hydrogen compartment cap portion 188 which is framed by the hydrogen compartment cap framing 178. A cooling unit 190 is located within the protective railing assembly 186 above the electronics compartment 164.

The containerized hydrogen pumping module 150 is configured to be shipped on a semi-trailer truck in a substantially completed configuration, also referred to herein as a main shipping assembly 200 shown in FIG. 6. To this end, the containerized hydrogen pumping module 150 is configured such that the structural components within the canopy region 156, as well as any functional component which extends into, or is a part of, the canopy region 156, are not part of the main shipping assembly 200. Rather, those components are configured to be easily assembled to the main shipping assembly 200 at a final location of the containerized hydrogen pumping module 150.

Accordingly, the structural components which are not assembled to the main shipping assembly 200 include the hydrogen compartment cap portion 188 and the protective railing assembly 186 which are shown in FIG. 6 not assembled to the main shipping assembly 200. In some embodiments, the cooling unit 190 is mounted to the protective railing assembly 186 for shipping.

The main shipping assembly 200 and the components which are not assembled with the main shipping assembly 200 during shipping are each sized to be less than the dimensions of a high-cube container. The outer dimensions of a high-cube container are 40 foot long, 8 foot wide, and 9 foot 6 inches high. The largest outer dimensions of the containerized hydrogen pumping module 150 in a shipping configuration are defined by the main shipping assembly 200. In one embodiment, the outer dimensions of the main shipping assembly 200, as shown in FIG. 6, are about 21.5 foot long (1), 6 foot wide (w), and 9.5 feet high (h). Consequently, the main shipping assembly 200 and the components of the containerized hydrogen pumping module 150 which are not assembled to the main shipping assembly 200 do not exceed the outer dimensions of a high-cube container. Thus, the containerized hydrogen pumping module 150 is easily shipped to a desired location using standard transport vehicles with minimal assembly required on-site as discussed in more detail below.

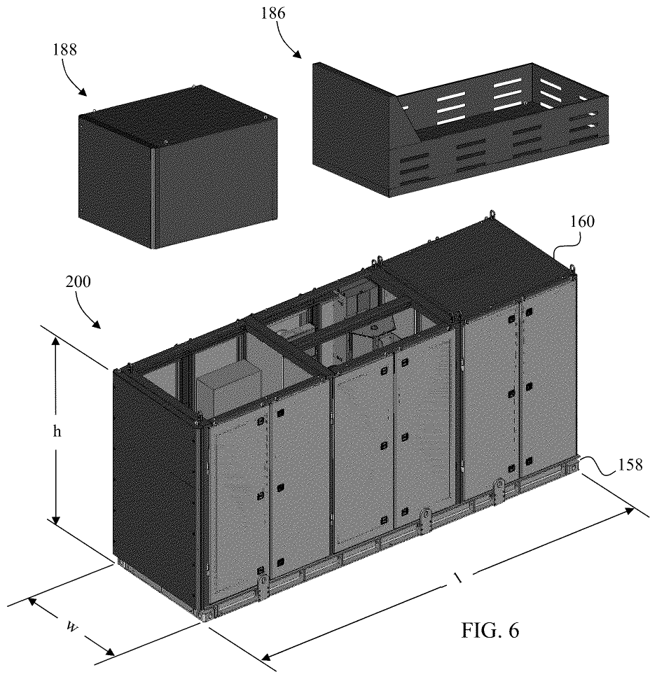

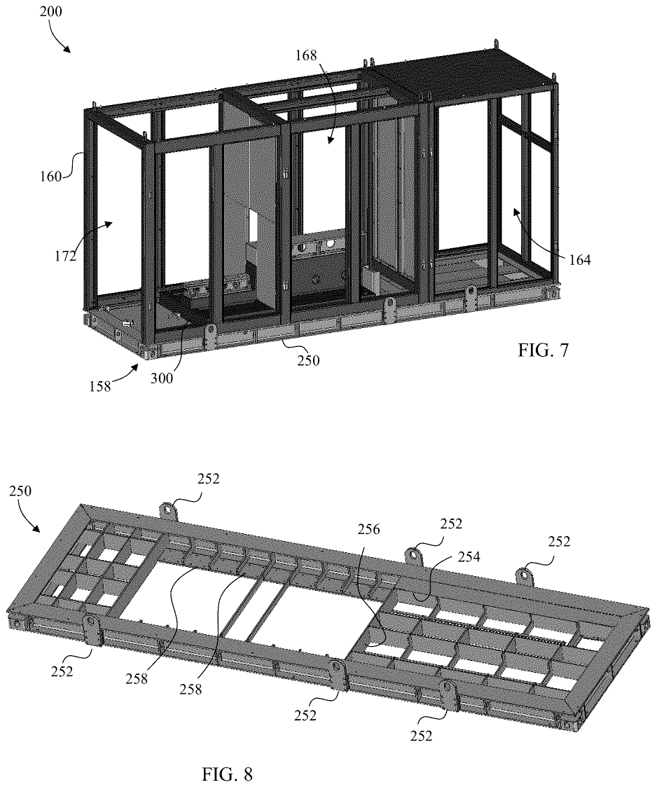

While the main shipping assembly 200 is shown in one configuration in FIG. 6, the minimum form of the main shipping assembly 200 is shown in FIG. 7. In FIG. 7, the main shipping assembly 200 includes the base portion 158 and the component portion housing 160 less the hydrogen compartment cap framing 178. While effective in providing a base to which the remaining components of the containerized hydrogen pumping module 150 can be mounted, the configuration of the main shipping assembly 200 allows for up to all of the assembly within the electronics compartment 164 and the hydraulic compartment 168 to be performed prior to shipping, along with some of the assembly within the hydrogen compartment 172. The extent of the assembly performed before shipping can thus be modified by omission of some of the components which are discussed below.

Further details of the containerized hydrogen pumping module 150 are provided in the following description of the manner in which the components of the containerized hydrogen pumping module 150 are assembled to form the main shipping assembly 200 and the containerized hydrogen pumping module 150. While provided in a sequential description, those of skill in the art will recognize that many of the sequences discussed below may be accomplished in parallel. Moreover, assembly of the containerized hydrogen pumping module 150 may be accomplished while modifying the order of many of the assembly steps.

Assembly of the containerized hydrogen pumping module 150 in one embodiment includes assembly of the base portion 158. The base portion 158 includes a structural frame 250 shown in FIG. 8 which functions as a base support component. A number of pad eyes 252 are rigidly attached to the structural frame 250. The structural frame 250 and the number of pad eyes 252 are designed to support at least the weight of the main shipping assembly 200. This allows the main shipping assembly 200 to be lifted from a trailer after arrival at a desired location using, e.g., a crane, and positioned at the desired location. The placement of the number of pad eyes 252 is selected to provide a balanced load during the crane operation.

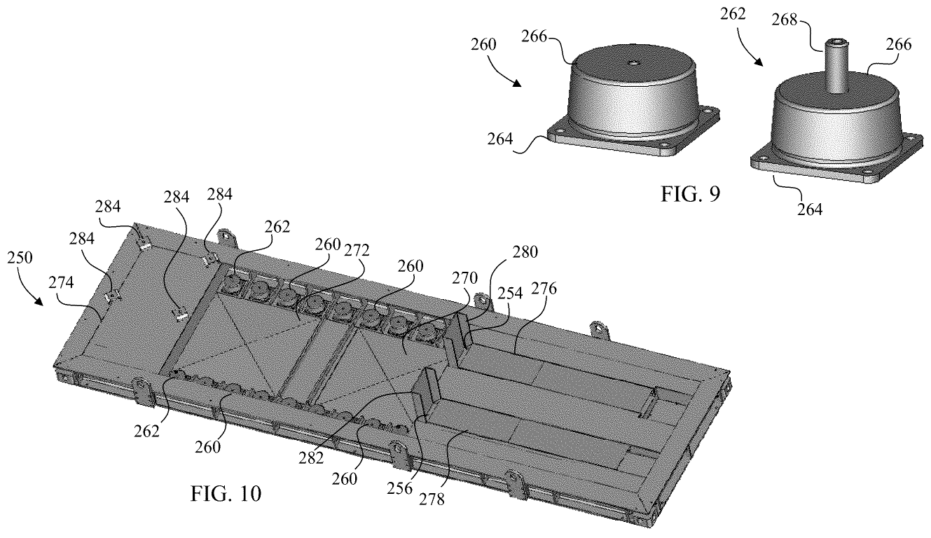

The structural frame 250, in addition to providing the required structural strength to allow for lifting the main shipping assembly 200 with a crane, is configured to provide electrical pathways between the electronics compartment 164 and the hydraulic compartment 168. To this end, wireway 254 and wireway 256 are defined by the structural frame 250. The wireway 254 and wireway 256 further define a portion of a ventilation path in some embodiments as discussed more fully below. A number of mounting areas 258 are also provided. The mounting areas 258 are configured to receive sound dampers such as sound damper 260 and sound damper 262 shown in FIG. 9. The sound damper 260 and sound damper 262 each include a respective lower portion 264 rigidly mounted to the structural frame 250 (see FIG. 10) and an upper portion 266 which is vibrationally isolated from the lower portion 264. The sound damper 262 includes an alignment pin 268. As shown in FIG. 10 in one embodiment twelve sound dampers 260 and four sound dampers 262 (only three are visible in FIG. 10) are provided. The exact number and type of sound dampers can be varied depending upon the load which they will support.

Continuing with FIG. 10, a number of stiffening plates such as plates 270, 272, and 274 are provided with the structural frame 250 along with wireway cover 276 and wireway cover 278 which cover wireway 254 and wireway 256, respectively. The wireway cover 276 and the wireway cover 278 are typically installed after running of cable within the wireway 254 and wireway 256 which is discussed in further detail below. Wire chase 280 extends upwardly from wireway 254 and wire chase 282 extends upwardly from wireway 256. Four tank supports 284 are provided on top of the plate 274.

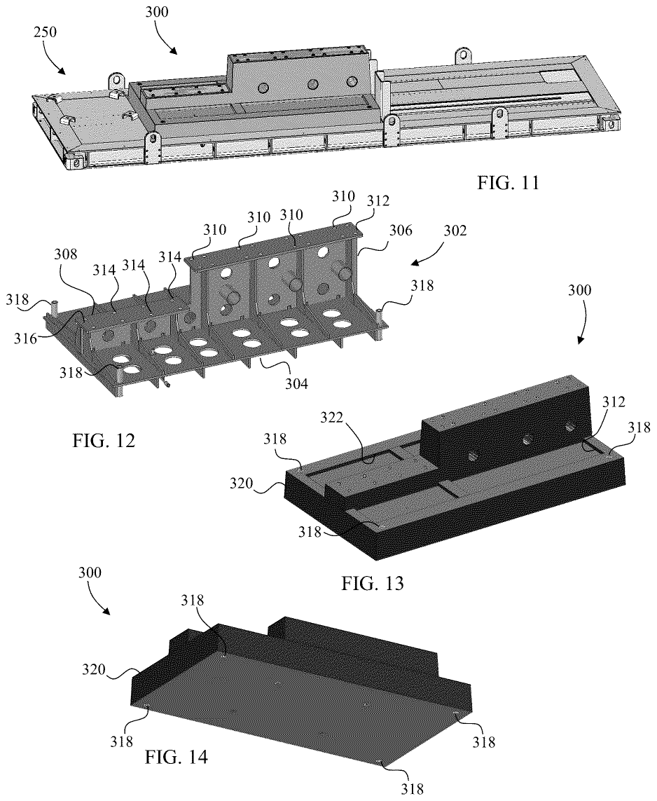

Once the sound dampers 260 and sound dampers 262 are mounted to the structural frame 250, a polymer concrete support assembly 300 is positioned on the sound dampers 260 and sound dampers 262 as shown in FIG. 11. The polymer concrete support assembly 300 includes a structural frame 302 shown in FIG. 12. The structural frame 302 includes a base frame 304, a hydraulic support frame 306, and a secondary pump support frame 308. Mounting holes 310 are provided in an upper support surface 312 of the hydraulic support frame 306 and mounting holes 314 are provided in an upper support surface 316 of the secondary pump support frame 308. Positioning receptacles 318 are rigidly attached to the base frame 304.

The positioning receptacles 318 extend completely through a polymer concrete coating 320, shown in FIGS. 13 and 14, which substantially encases the structural frame 302 with the exception of the positioning receptacles 318, the mounting holes 310, and the mounting holes 314. The structural frame 302 is shaped to assist in stabilizing the polymer concrete coating 320 as the polymer concrete coating 320 cures. The material for the polymer concrete coating 320 is selected for strength as well as resistance to chemicals and ability to retain those characteristics when exposed to extreme temperature variations. Resistance to degradation from hydraulic fluid and exposure to liquid hydrogen are particularly important. The polymer concrete coating 320 is shaped with basins 322 to collect fluid leakage. In some embodiments drainage ports are provided in the basins 322 to direct any leaking fluid to a storage container.

The polymer concrete support assembly 300 is positioned on the sound dampers 260 and sound dampers 262 by insertion of the alignment pins 268 within the positioning receptacles 318, resulting in the configuration of FIG. 11. Once the polymer concrete support assembly 300 is positioned on the sound dampers 260 and sound dampers 262 so as to be supported by the structural frame 250, the component portion housing 160 may be positioned on the structural frame 250 to provide the main shipping assembly 200 shown in FIG. 7. Advantageously, however, additional components in some embodiments are assembled to the main shipping assembly 200 prior to shipping.

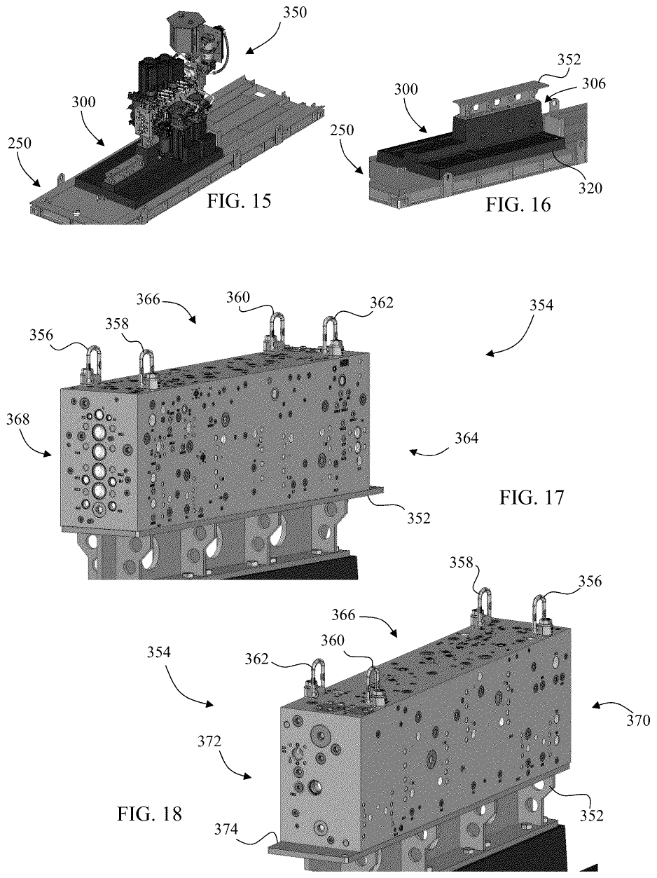

One such component is a hydraulic plant 350 shown positioned on the polymer concrete support assembly 300 in FIG. 15. Additional details regarding the hydraulic plant 350 are set forth in the discussion of the assembly of the hydraulic plant 350 onto the polymer concrete support assembly 300 set forth below.

Initially, a hydraulic support assembly 352 is rigidly attached to the hydraulic support frame 306 which is encased in the polymer concrete coating 320. In the embodiment of FIG. 16, this is accomplished using a plurality of bolts. Once the hydraulic support assembly 352 is positioned, a main hydraulic manifold 354, shown in FIGS. 17 and 18, is positioned on the hydraulic support assembly 352 using hoist rings 356, 358, 360, and 362. The main hydraulic manifold 354 is rigidly attached to the hydraulic support assembly 352 using bolts and/or another desired fixation structure.

The main hydraulic manifold 354 includes a first main support face 364, an upper support face 366, a hydrogen pump manifold connection face 368, a second main support face 370, and an auxiliary support face 372. An auxiliary support lip 374 of the hydraulic support assembly 352 is located next to the auxiliary support face 372.

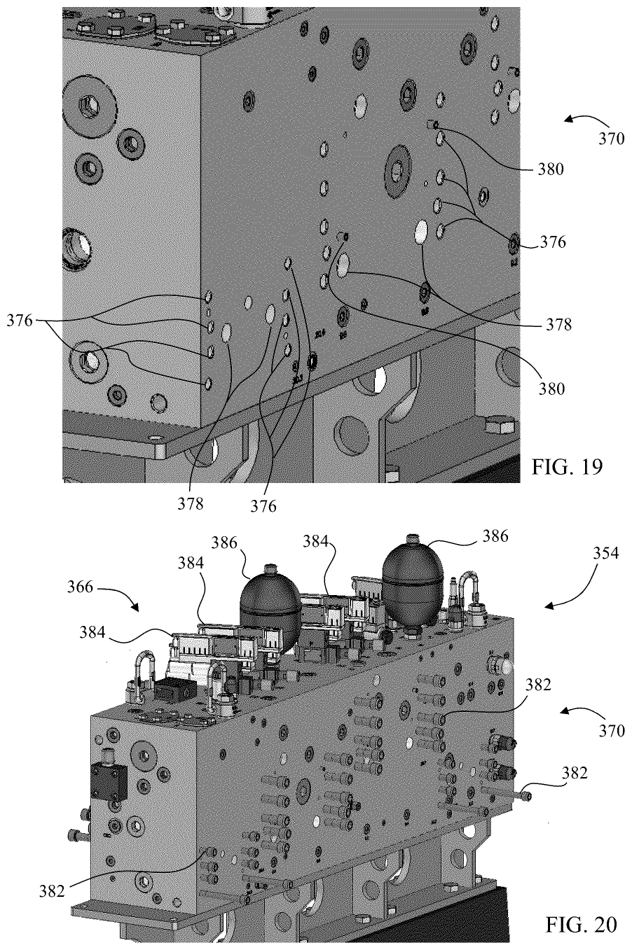

Each of the first main support face 364, upper support face 366, hydrogen pump manifold connection face 368, second main support face 370, and auxiliary support face 372 include a number of mounting connections and hydraulic fluid connections. By way of example, FIG. 19 shows a portion of the second main support face 370. Shown in FIG. 19 are mounting holes 376 and hydraulic fluid connections 378. Mounting studs 380 are also shown in FIG. 19. The mounting studs 380 assist in orienting and supporting components as they are attached to the main hydraulic manifold 354. The mounting studs 380 and/or the mounting holes 376 are configured to provide the sole support for the majority of the components of the hydraulic plant 350 including filters, and motor-pump units.

Once the main hydraulic manifold 354 is positioned, the other components of the hydraulic plant 350 are mounted to the main hydraulic manifold 354 and/or the hydraulic support assembly 352. In some embodiments, some of the components are mounted prior to mounting the main hydraulic manifold 354 on the hydraulic support assembly 352. By way of example, FIG. 20 shows the main hydraulic manifold 354 with a number of components installed on the upper support face 366 and some mounting bolts 382 installed in the mounting holes 376. Typically, however, only the main hydraulic manifold 354 is positioned using the hoist rings 356, 358, 360, and 362 to avoid damage to the components during installation.

In any event, the hydraulic components are installed on the main hydraulic manifold 354 typically beginning with installation of components on the upper support face 366. Thus, as seen in FIG. 20, a number of components 384 which may include electrically controlled valves, accumulators, etc. are mounted on the upper support face 366.

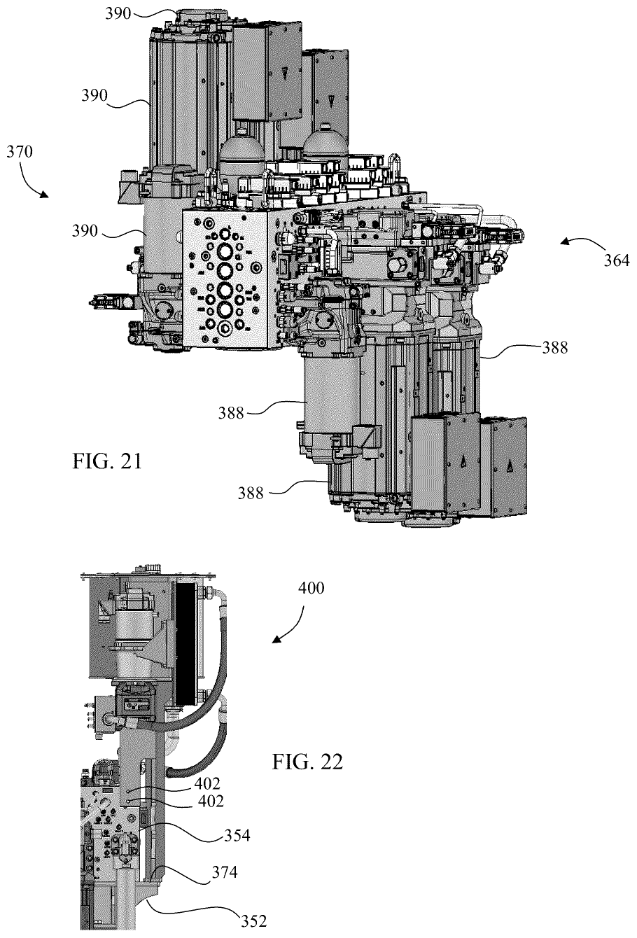

Additionally, components are mounted to the first main support face 364 and second main support face 370 as shown in FIG. 21, wherein the polymer concrete support assembly 300 and hydraulic support assembly 352 are not shown. In particular, first main face components 388 in various embodiments include components such as hydraulic pumps for one or more of the low-pressure pumps and the secondary stage pumps, hydraulic filter(s), pilot motor pump, hydraulic cylinders, etc. The first main face components 388 are direct mounted to the main hydraulic manifold 354. Similarly, second main face components 390 in various embodiments include components such as one or more hydraulic pumps for one or both of the low-pressure pumps and the secondary stage pumps, hydraulic filter(s), pilot motor pump, hydraulic cylinders, etc. The second main face components 390 are likewise direct mounted to the main hydraulic manifold 354.

Various auxiliary system components 400 (FIG. 22) are positioned on the auxiliary support lip 374 of the hydraulic support assembly 352, and connected to the auxiliary support lip 374. The various auxiliary system components 400 are further attached to the main hydraulic manifold 354 using bolts 402. The various auxiliary system components 400 in some embodiments include hydraulic reservoirs, heat exchangers such as an oil-to-glycol heat exchanger, motor-pump units for flushing, charging, cooling, and filtration. Structural assembly of the hydraulic plant 350 is completed by hydraulically connecting valves and fittings to the main hydraulic manifold 354 and/or hydraulic components.

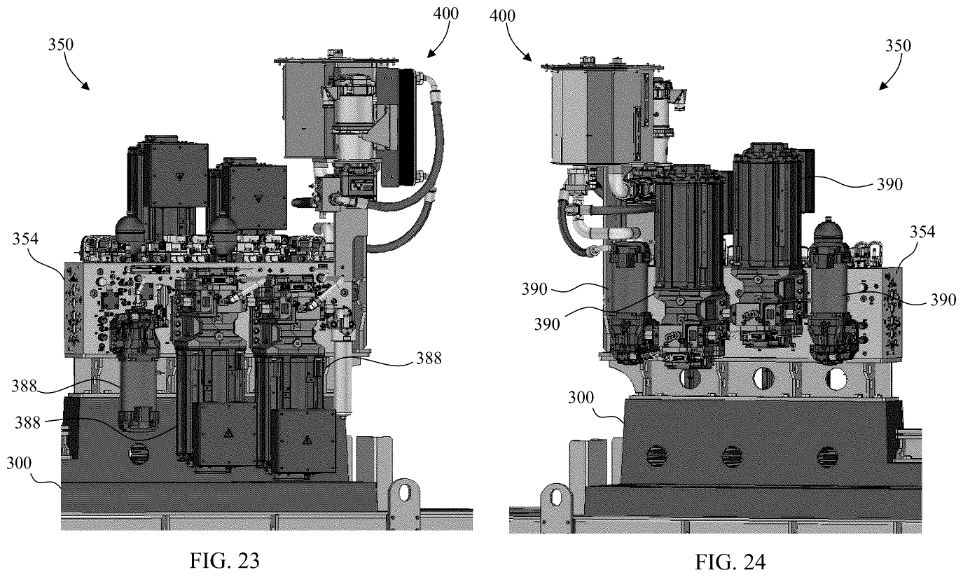

The main hydraulic manifold 354 thus provides a number of advantages. One advantage is that all of the first main face components 388, second main face components 390 and various auxiliary system components 400 are supported by the main hydraulic manifold 354 through the hydraulic support assembly 352. As shown in FIGS. 23 and 24, each of the first main face components 388 and second main face components 390, and various auxiliary system components 400 is spaced apart from the polymer concrete support assembly 300. Thus, the weight of the hydraulic plant 350 is centered on the polymer concrete support assembly 300 which maximizes the effectiveness of the sound dampers 260 and sound dampers 262.

Moreover, since the main hydraulic manifold 354 is centrally located, fitting connections and mountings are easily accessed either from directly above the main hydraulic manifold 354 or from one of the sides of the main hydraulic manifold 354. For example, FIG. 25 shows a number of mounting flanges 404 for the first main face components 388 which are all directly accessible from the side of the first main support face 364. Likewise, fitting connections 406 are all directly accessible from the side of the first main support face 364. Furthermore, control electronics connections 408 are directly accessible from the side of the first main support face 364.

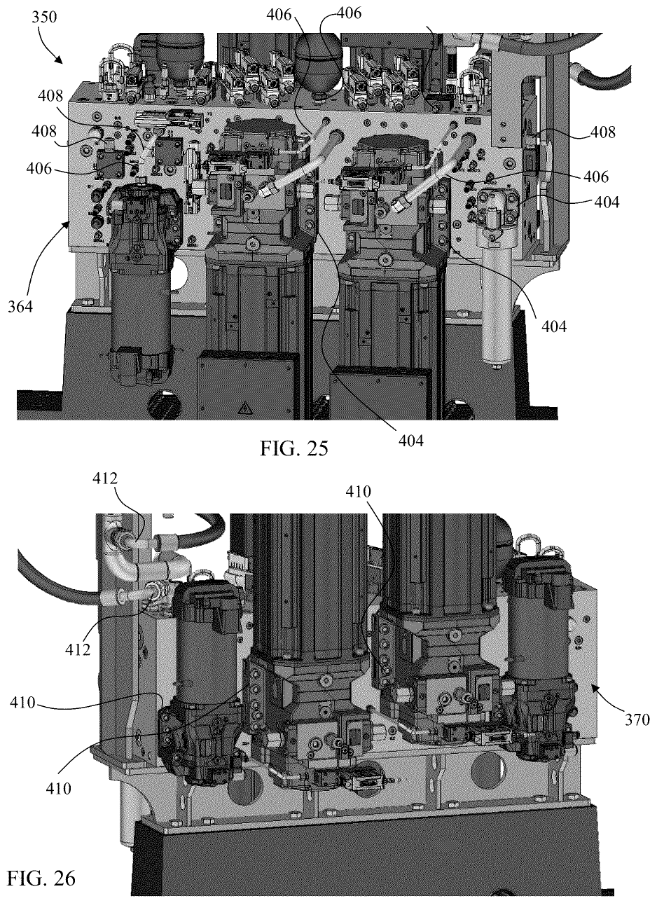

The second main face components 390 on the second main support face 370 are likewise configured to provide easy access from the side of the second main support face 370. As shown in FIG. 26, the mounting flanges 410 and fittings 412 are directly accessible from the second main support face 370. The mounting, fitting, and electrical connection configurations allow for a significantly smaller footprint for the main shipping assembly 200 since space for an individual to be positioned between components to access mounting areas is not required.

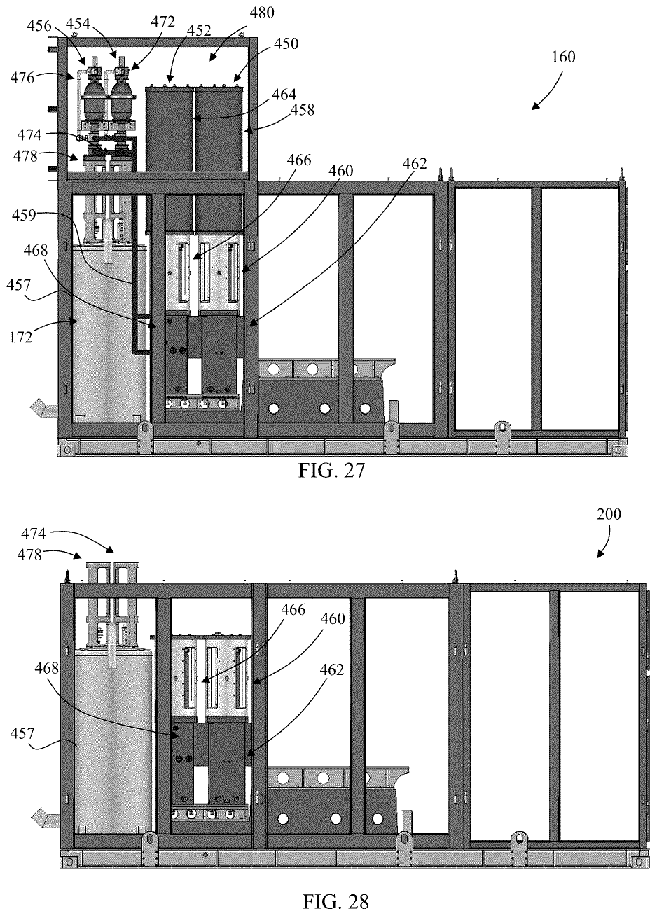

While all of the components within the hydraulic compartment 168 can be pre-assembled without exceeding the height of a high-cube container, all of the components which are positioned in the finally assembled containerized hydrogen pumping module 150 may not. By way of example, FIG. 27 shows some of the components which are positioned within the hydrogen compartment 172 in some embodiments including second stage pump 450, second stage pump 452, low-pressure pump 454, low-pressure pump 456, and vacuum jacketed sump 457. Hydraulic piping 459 is shown extending from the warm end portion 468 to the low-pressure pump 456 and low-pressure pump 454.

The second stage pump 450 and second stage pump 452 in one embodiment are configured like the second stage pumps described in U.S. application Ser. No. 18/636,132, filed Apr. 15, 2024, the contents of which are herein incorporated by reference in their entirety. The second stage pump 450 thus includes a cold end portion 458, an intermediate portion 460, and a warm end portion 462. Similarly, the second stage pump 452 includes a cold end portion 464, an intermediate portion 466, and a warm end portion 468. The second stage pump 450 and second stage pump 452 both extend into the hydrogen compartment cap portion 180 and thus cannot be fully assembled while fitting within the main shipping assembly 200.

The low-pressure pump 454 and the low-pressure pump 456 in this embodiment are configured similarly to the low-pressure pumps disclosed in U.S. application Ser. No. 19/001,249, filed Dec. 24, 2025, the contents of which are incorporated herein by reference in their entirety. The low-pressure pump 454 includes a warm end portion 472 and an intermediate portion 474. The low-pressure pump 456 includes a warm end portion 476 and an intermediate portion 478. Cold-end portions of the pumps are positioned within the vacuum jacketed sump 457 and are not shown.

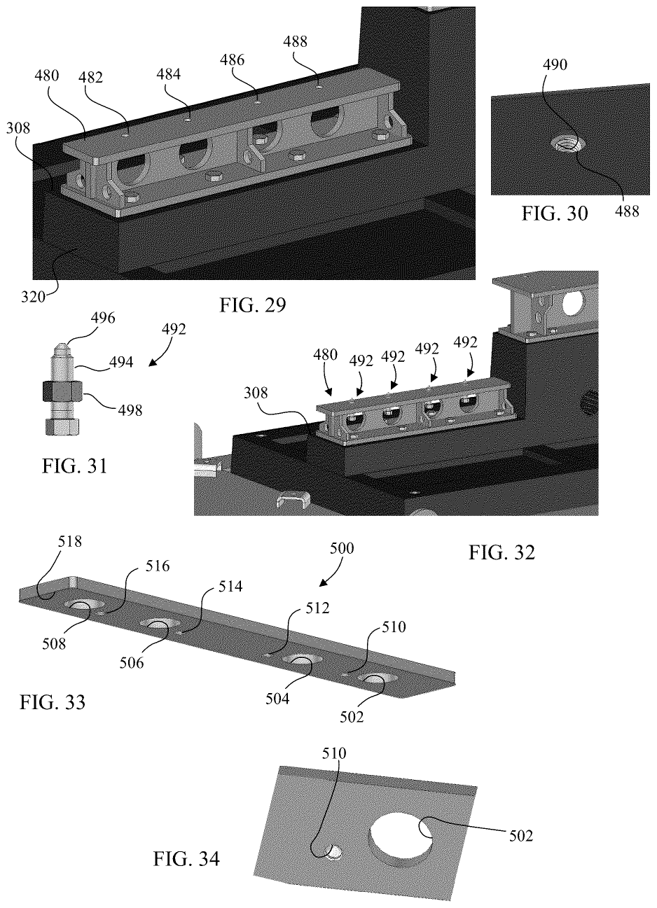

The warm end portion 472, and the warm end portion 476 each extend into the hydrogen compartment cap portion 180 and thus cannot be fully assembled while fitting within the main shipping assembly 200 dimensions. Likewise, the cold end portion 458 and the cold end portion 464 extend into the hydrogen compartment cap portion 180. Accordingly, in some embodiments of the main shipping assembly 200 these components are not assembled into the main shipping assembly 200, resulting in the configuration of FIG. 28. The main shipping assembly 200 in FIG. 28 includes the intermediate portion 460, the warm end portion 462, the intermediate portion 466, and the warm end portion 468. The vacuum jacketed sump 457, intermediate portion 478 and intermediate portion 474 are also included. In some embodiments, the intermediate portion 474 and intermediate portion 478 are omitted to fit within the height limitation of a high-cube container. Assembly of the main shipping assembly 200 of FIG. 28 in some embodiments is discussed with initial reference to FIG. 29.

As shown in FIG. 29, a base member 480 is rigidly attached to the secondary pump support frame 308 which is encased in the polymer concrete coating 320. In the embodiment of FIG. 29, this is accomplished using a plurality of bolts. The base member 480 includes through hole 482, through hole 484, through hole 486, and through hole 488. Each of the through holes is internally threaded as seen with the internal threads 490 of the hole 488 shown in FIG. 30.

A screw 492 shown in FIG. 31 is provided in each of the through holes. Each of the plurality of screws 492 includes a threaded shaft 494 and a shaped end portion 496. The shaped end portion in the embodiment of FIG. 31 is a truncated cone. In other embodiments, a spherical shape is provided. A nut 498 is provided on the threaded shaft 494. Each of the threaded through holes is provided with a respective screw 492 as shown in FIG. 32.

An adjustable support plate 500 is shown in FIG. 33. The adjustable support plate 500 includes mounting bore 502, mounting bore 504, mounting bore 506, and mounting bore 508. Each of the mounting bores extend completely through the adjustable support plate 500. The adjustable support plate 500 further includes cavity 510, cavity 512, cavity 514, and cavity 516. The cavities are provided on the lower surface 518 of the adjustable support plate 500 and typically do not extend completely through the adjustable support plate 500. The cavities are shaped complementarily to the shaped end portions 496 of the screws 492 as shown by the cavity 510 in FIG. 34.

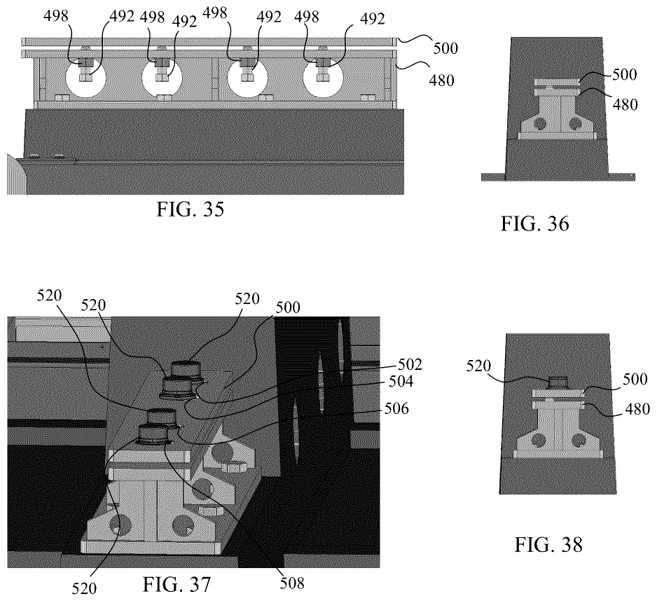

Positioning of the screws 492 in the respective mounting bore 504 results in the configuration of FIGS. 35 and 36, wherein the adjustable support plate 500 is supported by the screws 492, although the adjustable support plate 500 may be positioned alternatively or additionally directly on the base member 480. By rotating the screws 492 within the holes 482, a precise horizontal positioning of the adjustable support plate 500 is possible. The nuts 498 are then used to fix the position of the screws 492. The shaped end portion 496 and shape of the cavity 510 provide an increased surface contact between the shaped end portion 496 and the cavity 510 when it is desired to create a non-parallel configuration between the adjustable support plate 500 and the base member 480. Accordingly, the adjustable support plate 500 can be used to precisely position the second stage pump 450 and second stage pump 452 with respect to the first main support face 364 of the main hydraulic manifold 354 as discussed further below.

After the adjustable support plate 500 is supported by the base member 480 secondary pump mounts 520 are positioned within respective ones of the mounting bore 502, mounting bore 504, mounting bore 506, and mounting bore 508 as shown in FIGS. 37 and 38. While four secondary pump mounts 520 are shown in FIG. 37, in some instances only the two secondary pump mounts 520 closest to the hydraulic support frame 306 are initially installed prior to the next step.

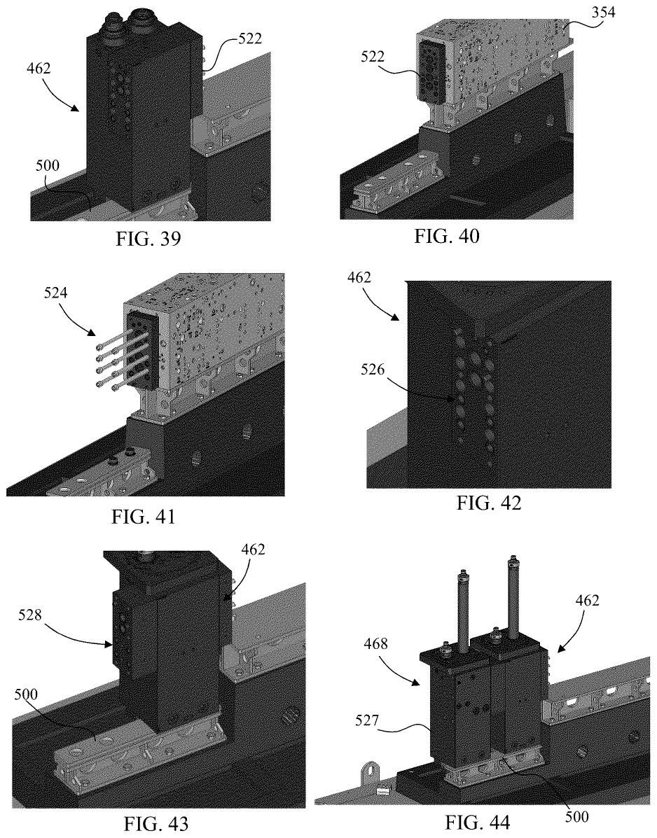

Once the two secondary pump mounts 520 closest to the hydraulic support frame 306 are installed, the warm end portion 462 of the second stage pump 450 is positioned on the two secondary pump mounts 520 and the adjustable support plate 500 as shown in FIG. 39. In embodiments wherein the hydraulic plant 350 is not installed, a first sub-manifold 522 may be positioned on the warm end portion 462. Alternatively, if the main hydraulic manifold 354 is installed, the first sub-manifold 522 may first be mounted to the main hydraulic manifold 354 (see FIG. 40) followed by positioning of the warm end portion 462.

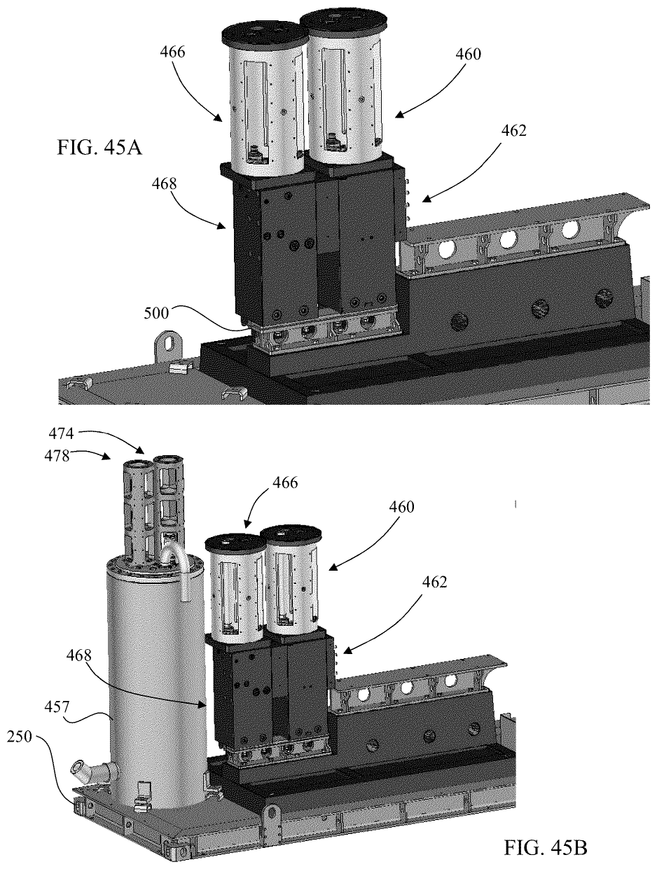

Within the warm end portion 462, a plurality of hydraulic conduits 524 are provided as shown in FIG. 41 wherein the remainder of the warm end portion 462 is not shown. The plurality of hydraulic conduits 524 are in fluid connection with a manifold mounting face 526 (FIG. 42). A second sub-manifold 528 shown in FIG. 43 is mounted to the manifold mounting face 526 of the warm end portion 462. Then the warm end portion 468 is mounted on two secondary pump mounts 520 and the adjustable support plate 500 as shown in FIG. 44. If desired, the intermediate portion 460 and the intermediate portion 466 are mounted to the warm end portion 462 and the warm end portion 468 as shown in FIG. 45A. The warm end portion 468 includes a mounting face 527 shown in FIG. 44. The manifold mounting face 527 is operably connected to the low-pressure pump 454 and low-pressure pump 456 for operation using the hydraulic piping 459 shown in FIG. 27. Once the warm end portion 462 and warm end portion 468, and in some embodiments the intermediate portion 460 and the intermediate portion 466 are mounted, the vacuum jacketed sump 457 is mounted to the structural frame 250 as shown in FIG. 45B. If desired, all or portions of the intermediate portion 474 and intermediate portion 478 are then mounted to the vacuum jacketed sump 457.

Since the components in the electronics compartment 164 are not as noisy as the components in the hydraulic compartment 168 or hydrogen compartment 172, they are not mounted on the polymer concrete support assembly 300. Thus, as shown in FIG. 46, the electrical component assembly 550 is mounted directly to the structural frame 250. Electrical connections from the electrical component assembly 550 are routed through the wireway 254 and wireway 256 in the structural frame 250 (see FIG. 8), and up along the wire chase 280 and wire chase 282. While the electrical component assembly 550 may be assembled in location on the structural frame 250, in some embodiments the electrical component assembly 550 is assembled remotely from the structural frame 250. The electrical component assembly 550 is then maneuvered onto the structural frame 250 using hoist rings 552.

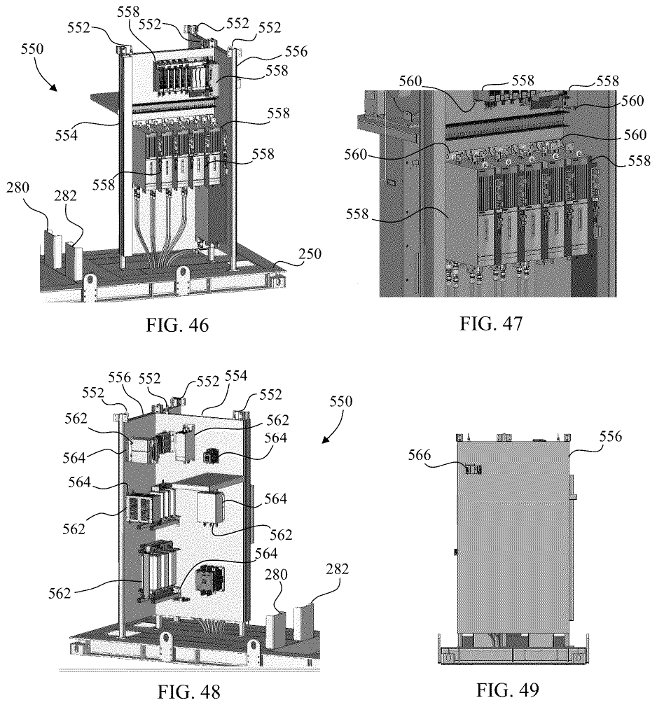

The electrical component assembly 550 includes a main support panel 554 and an auxiliary support panel 556. The various electrical components 558 shown in FIG. 46 are mounted to the main support panel 554 and/or the auxiliary support panel 556 so that the mounting portions 560, shown in FIG. 47, are readily accessible from the side of the main support panel 554 shown in FIG. 46. FIG. 48 shows the opposite side of the main support panel 554 along with further electrical components 562 which include mounting portions 564 for mounting the further electrical components 562 on the main support panel 554 and/or the auxiliary support panel 556, which are readily accessible from the side shown in FIG. 48. Electrical components such as the electrical component 566 (see FIG. 49) may further be mounted on the side of the auxiliary support panel 556 shown in FIG. 49.

It is to be appreciated that while the figures have depicted the mounting of a number of components in each of the electronics compartment 164, hydraulic compartment 168, and hydrogen compartment 172, additional or fewer components are optionally mounted prior to shipping of the main shipping assembly 200. Moreover, in other embodiments different architectures may be selected for incorporation into a containerized hydrogen pumping module 150, such as more or fewer hydrogen pumps, only low-pressure pumps, etc. Such modifications are within the scope of the present disclosure.

Referring back to FIG. 7, the main shipping assembly 200 includes the component portion housing 160. While the foregoing discussion did not refer to the assembly of the component portion housing 160, in some embodiments the component portion housing 160 is assembled immediately after positioning of the polymer concrete support assembly 300 on the structural frame 250. Such assembly in some embodiments is undertaken directly on the structural frame 250.

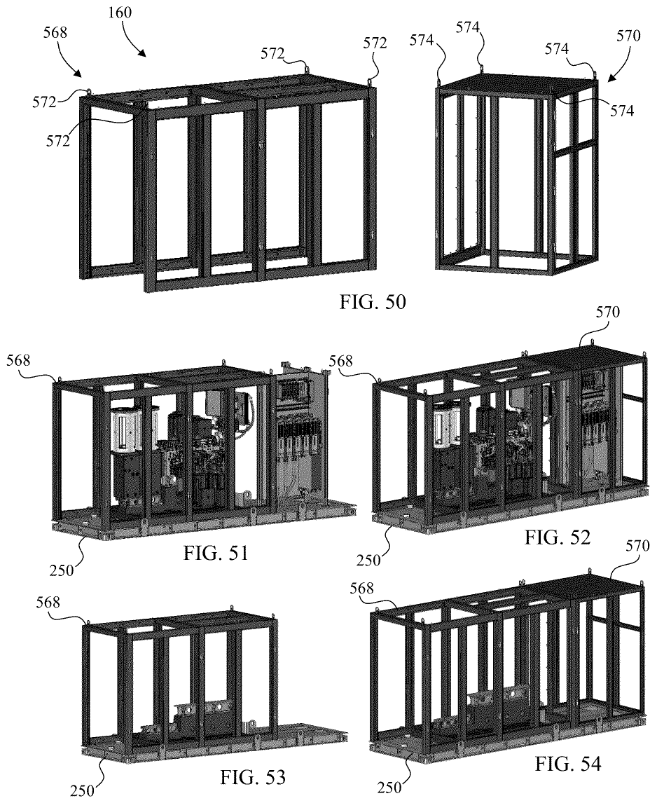

In other embodiments, at least portions of the component portion housing 160 are pre-assembled and then positioned on the structural frame 250. By way of example, FIG. 50 shows the component portion housing 160 pre-assembled into a frame sub-assembly 568 and a frame sub-assembly 570. Once the frame sub-assembly 568 is preassembled, the hoist rings 572 are used to position the frame sub-assembly 568 onto the structural frame 250 as shown in FIG. 51. Once the frame sub-assembly 570 is preassembled, the hoist rings 574 are used to position the frame sub-assembly 570 onto the structural frame 250 as shown in FIG. 52.

Alternatively, the frame sub-assembly 568 and the frame sub-assembly 570 can be pre-assembled and positioned on the structural frame 250 prior to installing any of the other components on the structural frame 250 as shown in FIGS. 53 and 54. This is because the main hydraulic manifold 354, the main support panel 554, and the auxiliary support panel 556 along with the components supported by them are configured to allow for mounting of the components from the sides or the top of the containerized hydrogen pumping module 150.

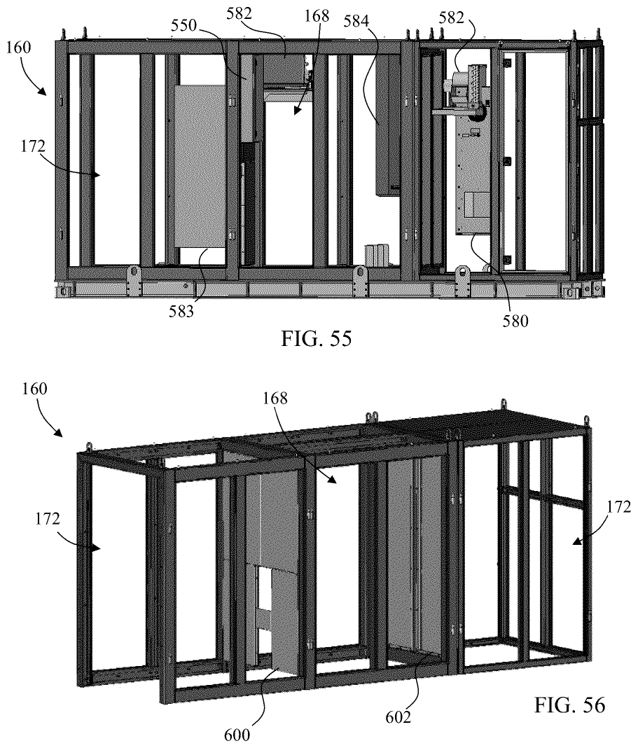

Once the component portion housing 160 is assembled additional components may be supported by the component portion housing 160 as desired. By way of example, FIG. 55 shows cabinet chiller 580, cooling chillers 582, hydrogen-glycol heat exchanger 583, and chiller 584 mounted to the component portion housing 160. The precise locations and components can vary according to design desires. In some embodiments, multiple types of cabinet chillers 580 are incorporated. The chillers and/or coolers are provided to dehumidify air in the containerized hydrogen pumping module 150 to reduce icing issues.

The hydrogen heat exchanger 583 uses hydrogen moving between the second stage pump system 108 and the dispensing unit 112 along the supply line 123 to chill glycol which is directed to the oil-to-glycol heat exchanger in the various auxiliary system components 400. This preheats the hydrogen which exits the second stage pump system 108 in a super critical fluid phase since the hydrogen must be heated to a liquid phase. The cooling provided to the glycol in the hydrogen-glycol heat exchanger 583 is typically sufficient to provide all of the cooling needed for the hydraulic plant 350 through the oil-to-glycol heat exchanger in the various auxiliary system components 400 when fuel is being provided to the dispensing unit 112. The cooling unit 190 is used to provide cooling when hydrogen is not moving through the supply line 123.

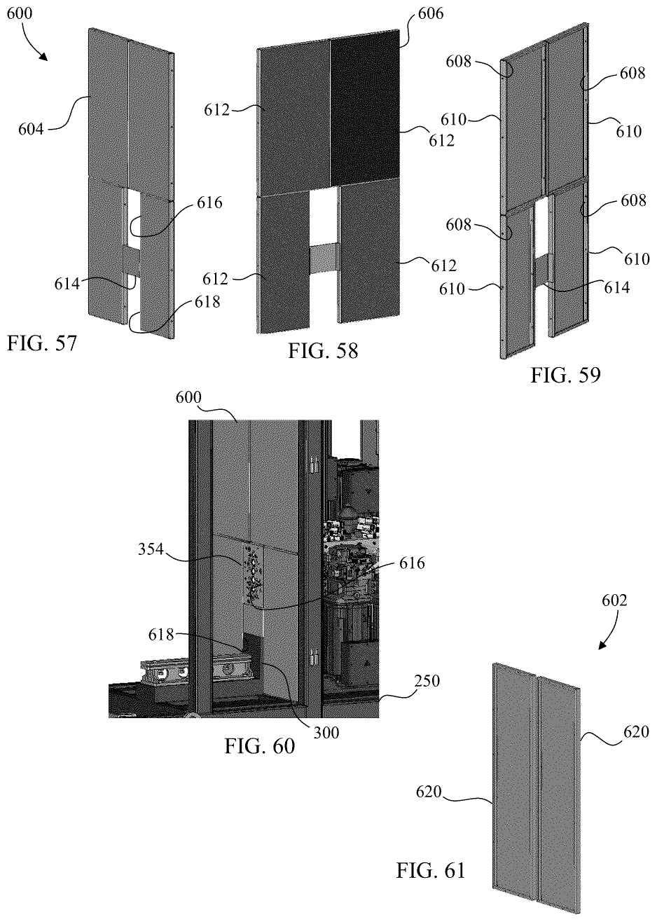

Also included within the main shipping assembly 200 are internal wall 600 and internal wall 602 shown in FIG. 56. The internal wall 600 separates the hydraulic compartment 168 from the hydrogen compartment 172. The internal wall 602 separates the hydraulic compartment 168 from the electronics compartment 164. The internal wall 600 is discussed in further detail with reference to FIGS. 57-59.

The internal wall 600 includes a hydrogen compartment facing side 604 and a hydraulic compartment facing side 606. The side 604 is preferably formed from a material that is chemically resistant to hydrogen and water/ice, and stable over a wide range of temperatures since it can be exposed to freezing temperatures. The side 604 forms a shell with hollow spaces 608 (FIG. 59) which are covered by the side 606. The side 606 is formed from a material which is stable in the presence of hydraulic fluid. The side 604 is formed with panels 610 while the side 606 is formed from panels 612. A cross-piece 614 forms a manifold opening 616 and a polymer concrete support assembly opening 618.

The panel and crosspiece configuration aids in forming the internal wall 600 when the main hydraulic manifold 354 is already in place on the structural frame 250. As shown in FIG. 60, the main hydraulic manifold 354 extends through the internal wall 600, and in particular, through the manifold opening 616. The polymer concrete support assembly 300 extends through the polymer concrete support assembly opening 618. Thus, the internal wall 600 can be easily assembled even after the polymer concrete support assembly 300 and the main hydraulic manifold 354 are assembled to the structural frame 250.

Advantageously, because the main hydraulic manifold 354 provides all of the hydraulic connections for the low-pressure pump 454, low-pressure pump 456, second stage pump 452, and second stage pump 450, sealing of the hydraulic compartment 168 from the hydrogen compartment 172 is facilitated. Accordingly, in one embodiment the hydraulic compartment 168 is vapor sealed from the hydrogen compartment 172 by the internal wall 600. This allows for design of a precise ventilation path between the compartments as discussed in further detail below.

The internal wall 602 shown in FIG. 61 is formed as two panels 620. The internal wall 602 is configured to provide splash protection of the electrical component assembly 550 from the hydraulic plant 350.

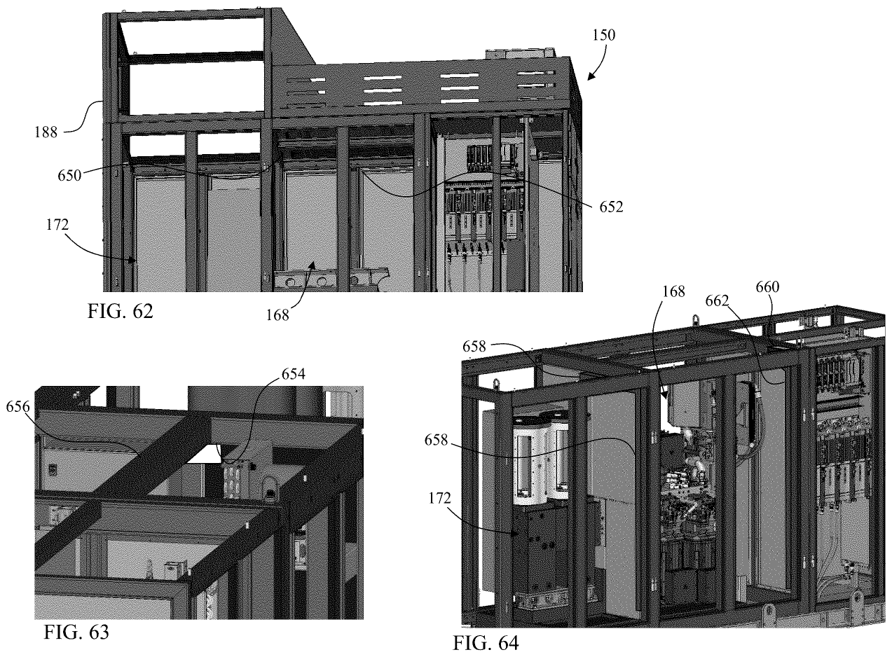

As noted above the internal wall 600 is sealed which prevents migration of any hydrogen leakage in the hydrogen compartment 172 from moving into the hydraulic compartment 168. So as to maximize safety, however, in some embodiments a ventilation path is provided from the hydraulic compartment 168 to the hydrogen compartment 172 and from the hydrogen compartment 172 to an outside environment. This ventilation path is described in further detail with reference to FIG. 62 wherein various components and structures of the containerized hydrogen pumping module 150 are not shown for purpose of clarity.

Since hydrogen gas is lighter than air, hydrogen which leaks into a compartment and transitions to a gaseous state, will migrate to the highest level of a compartment. Accordingly, within the hydraulic compartment 168 any hydrogen gas will rise to the ceiling and into bay 650 and/or bay 652. Within the hydrogen compartment 172, hydrogen gas will rise to the top of the hydrogen compartment cap portion 188. A ventilation path, described below, is provided to remove any hydrogen gas in the hydraulic compartment 168 and the hydrogen compartment 172 which has leaked into those compartments.

Because hydrogen gas is combustible, many areas have specific codes dealing with the handling of hydrogen including cryogenic hydrogen. Such codes in some instances are based upon the Nationale Electric Code (NEC) and National Fire Protection Association (NFPA) 55, and typically establish requirements for ventilation of spaces including restricting the location of external vents to a minimum or maximum height. Some codes thus require a vent to be located between 3 and 12 inches of the ceiling or floor for lighter than air/heavier than air vents, respectively. Additionally, systems are typically required to operate continuously or to automatically operate in response to a detection system. The ventilation rate is also established and in some instances is required to be on the order of not less than 1 cubic foot per minute per square foot of floor area, with a minimum of 150 CFM.

Therefore, since the entire square footage of the containerized hydrogen pumping module 150, which in some embodiments is configured to receive and/or pump cryogenic hydrogen, is 129 square feet, the ventilation system for the containerized hydrogen pumping module 150 in one embodiment is sized for 150 CFM. Additionally, since the bay 650 and bay 652 are separated by a beam of less than 12 inches in height, a single exit vent for the hydraulic compartment 168 that is between 3-12 inches from the ceiling of the hydraulic compartment 168 is sufficient to remove hydrogen gas from the hydraulic compartment 168.

As shown in FIG. 63, a wall vent 654 is positioned beneath the frame piece 656 through the internal wall 600. Within the hydrogen compartment 172, so as to preclude hydrogen from travelling through the wall vent 654 from the hydrogen compartment 172 to the hydraulic compartment 168, the wall vent 654 is in fluid communication with a conduit 658 which extends to a location within twelve inches of the floor of the hydrogen compartment 172 as shown in FIG. 64. Depending upon the code for the area in which the hydrogen pumping system 100 is located, the conduit 658 may terminate higher than the height indicated in FIG. 64. The conduit 658 is constructed to reduce sound transmission from the hydraulic compartment 168 into the hydrogen compartment 172 while providing the desired airflow. The conduit 658 is attached to the main hydrogen framing 174 in a sound dampened manner.

Air is supplied to the hydraulic compartment 168 through a vent 660 which is in fluid communication with a conduit 662. The vent 660 and conduit 662 are connected to the hydraulic compartment framing 166 in a sound dampened manner. The vent 660 is connected to an external conduit (not shown) external to the containerized hydrogen pumping module 150 within the protective railing assembly 186. The external conduit and/or the conduit 662 are configured to preclude noise transmission from the hydraulic compartment 168 to the outside environment. Additionally, the external conduit, which in some embodiments is positioned within the protective railing assembly 186, is screened to preclude entrance of small animals or birds into the external conduit. In some embodiments. the conduit 662 is omitted and the vent 660 is positioned in fluid communication with the external environment at a height of 3-12 inches from the floor of the hydraulic compartment 168.

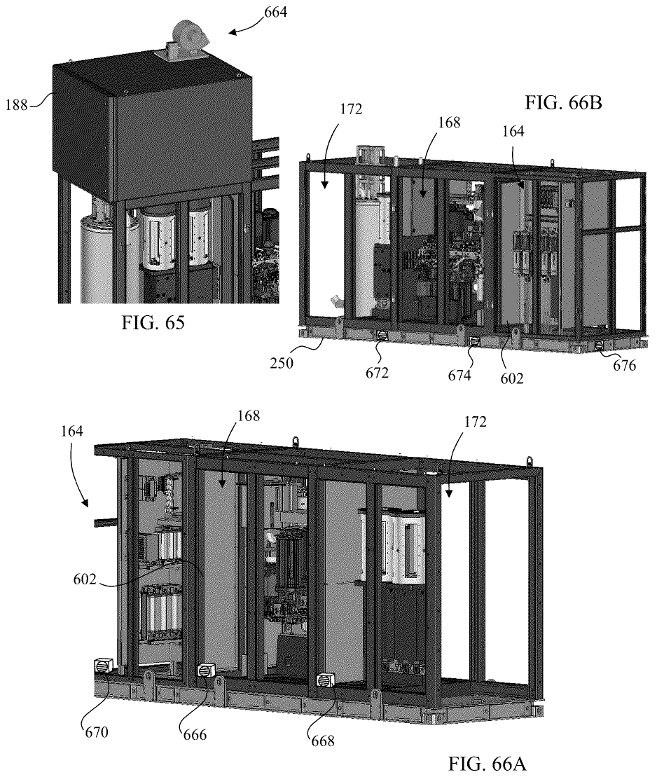

While typically not part of the main shipping assembly 200, at least one blower is further provided to take a suction on the hydrogen compartment 172 or to apply overpressure to the hydraulic compartment 168. In one embodiment a blower 664 is provided on the hydrogen compartment cap portion 188 as shown in FIG. 65. In some embodiments, the blower 664 is located on the side of the hydrogen compartment cap portion 188. The orientation of the external conduit and the blower 664 are configured to preclude hydrogen gas expelled by the blower 664 from entering the external conduit.

Rather than using the conduit 662, in some embodiments a vent 666 is provided to connect the hydraulic compartment 168 to the outside environment as shown in FIG. 66A. The vent 666, which is positioned within 3-12 inches of the floor of the hydraulic compartment 168, in some embodiments is a check valve which only allows air to flow into the hydraulic compartment 168. In some embodiments the vent 666 is a controllable vent which opens under, for example, hydraulic control. In some embodiments, a vent 668 is provided for the hydrogen compartment 172. In these embodiments, the wall vent 654 (see FIG. 63) is omitted and a second blower 664 is operably connected to the hydraulic compartment 168. Thus, each of the hydraulic compartment 168 and the hydrogen compartment 172 can be individually ventilated.

Additionally, and/or alternatively, a vent 670 is provided in the electronics compartment 164 as shown in FIG. 66. In these embodiments, the ventilation path extends from the electronics compartment 164 under the internal wall 602, through the hydraulic compartment 168, through the wall vent 654 and into the conduit 658. While the vents are shown in various locations in FIG. 66A, other locations are selected in other embodiments. By way of example, FIG. 66B shows a vent 672, vent 674, and vent 676 which are provided in the structural frame 250. The shows vent 672, vent 674, and vent 676 are in different embodiments provided alternatively and/or additionally to one or more of the vent 666, vent 668, and vent 670. The vent 676 allows air to be drawn from the environment through the wireway 256, beneath the internal wall 602 into the hydraulic compartment 168. This reduces the amount of noise which escapes the main shipping assembly 200/containerized hydrogen pumping module 150. The ventilation path in some embodiments extends along the wire chase 282 into the hydraulic compartment 168. The precise number and locations of the vents can be modified for particular installation situations. Additionally, in some embodiments external conduits are provided to provide a suction location for the vent which is at least 15 feet from a hydrogen leak source.

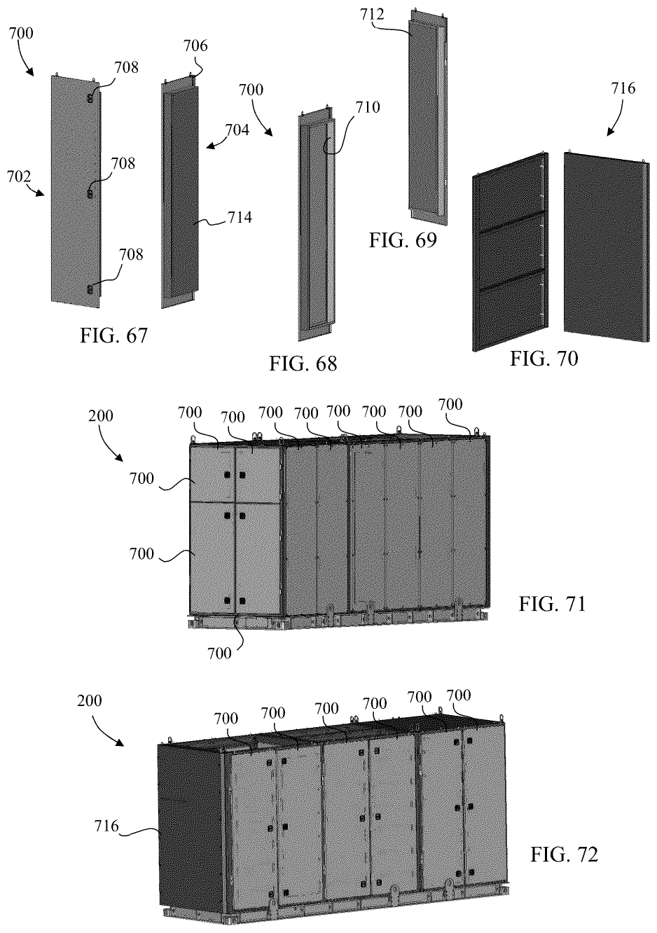

Once the component portion housing 160 has been assembled, and typically after positioning of the component portion housing 160 on the structural frame 250, doors and panels are provided for the main shipping assembly 200. One such door, door 700, is shown in FIG. 67. The door 700 includes an outer side 702 and an inner side 704. The outer side 702 is configured to provide weather protection while the inner side 704 is in some instances configured for the particular compartment with which it is associated. By way of example, the door 700 associated with the hydraulic compartment 168 will be resistant to degradation when exposed to hydraulic fluid. In some embodiments, the inner side 704 of a door 700 associated with the electronics compartment 164 is fire-resistant.

The door 700 is provided with hinges 706 which are used to connect the door 700 to the component portion housing 160, and latch assemblies 708 which are used to lock the door 700 to the component portion housing 160. As shown in FIG. 68, the door 700 defines a cavity 710. Insulation 712 shown in FIG. 69 is positioned within the cavity 710 in some of the doors. The cavity 710 provides sound isolation for the door 700. Some of the doors do not need the extra insulation, and the cavity 710 and cover 714 (see FIG. 67) are omitted. Additionally, depending upon the layout of the component portion housing 160 and the components within the containerized hydrogen pumping module 150, doors may not be required for each opening of the component portion housing 160 to the outside. Accordingly, panels 716, one example of which is shown in FIG. 70, may be provided. The panels 716 are bolted on and are incorporated for access to the containerized hydrogen pumping module 150 which is infrequently required.

Since the doors and panels provide access to any desired area of the main shipping assembly 200, it is possible to first assemble the component portion housing 160 and the panels and doors prior to positioning components within the main shipping assembly 200. While not typically done during initial installation, this capability is extremely helpful when maintenance or replacement of components is to be undertaken. The configuration of the main shipping assembly 200 with panels and doors installed is shown in FIGS. 71 and 72. The numbers, positions, and shapes of the panels and doors is modified in different embodiments depending upon the particular component layout within the main shipping assembly 200.

Moreover, due to the small footprint of the containerized hydrogen pumping module 150 (see FIG. 6), the centralized location of the polymer concrete support assembly 300 (see FIG. 16) and main hydraulic manifold 354, and the main support panel 554 (see FIG. 46), and the component configuration such as the positioning of the mounting flanges, the components within the containerized hydrogen pumping module 150 are readily accessible from outside of the containerized hydrogen pumping module 150. Thus, any desired component can be easily accessed and removed. For larger components, portions of the ceiling can be removed to allow the component to be lifted out of the containerized hydrogen pumping module 150.

So as to further ease maintenance, in some embodiments components which require more frequent access for maintenance are located on the same side of the main hydraulic manifold 354 or main support panel 554. By way of example, in one example, the first main face components 388 of FIG. 23 are predominantly selected to be the higher maintenance components. Likewise, the various electrical components 558 are selected to be those which typically require more maintenance.

Once the main shipping assembly 200 is assembled to the extent desired, the main shipping assembly 200 along with the other components of the containerized hydrogen pumping module 150 are loaded on a semi-trailer, and shipped to the location at which the containerized hydrogen pumping module 150 is to be installed. Since the containerized hydrogen pumping module 150, including the vacuum jacketed sump 457, is self-contained, there is no need to prepare a hole in which the vacuum jacketed sump 457 is placed as in some other systems. Rather, the site simply needs to be otherwise prepared to have the containerized hydrogen pumping module 150 properly supported while complying with other code restrictions such as property line set-offs, medical facility set-offs, etc. Once at the site, the number of pad eyes 252 are used to lift the main shipping assembly 200 off of the semi-trailer and position the main shipping assembly 200 at the site.

Once the main shipping assembly 200 is positioned, the portions of the low-pressure pump 454, portions of the low-pressure pump 456, and portions of the second stage pump 450 and second stage pump 452 not previously assembled to the main shipping assembly 200 are assembled. Typically, these components are shipped on the same semi-trailer, and can be positioned using the same equipment used in lifting the main shipping assembly 200 (e.g., a crane). If not previously done, the vacuum jacketed sump 457 is positioned on the four tank supports 284. The remaining components of the containerized hydrogen pumping module 150 are then assembled to the component portion housing 160 including the hydrogen compartment cap portion 188 and the protective railing assembly 186. Components positioned outside of the enclosed portion of the containerized hydrogen pumping module 150 such as the cooling unit 190, the blower 664, and other external conduits/piping are then assembled.

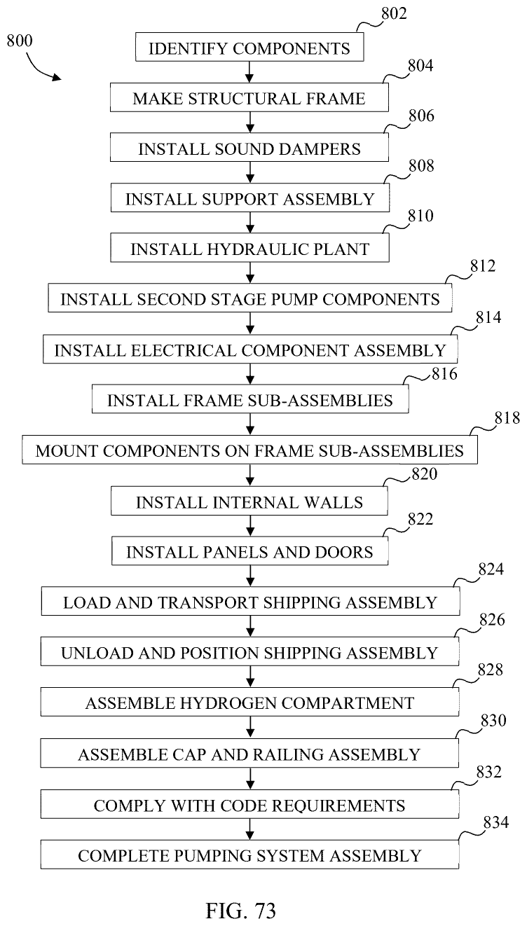

A method of assembling the hydrogen pumping system 100 is described with reference to FIG. 73 which shows an assembly process 800. While set forth in a particular sequence, as noted above, many of the identified steps can be done in different orders and/or simultaneously. The assembly process 800 begins with identifying the particular components to be included in the main shipping assembly 200 at block 802. Since the main shipping assembly 200 is deigned to provide ready access to the components positioned therein, if necessary, one or more components normally included in the main shipping assembly 200 may be omitted. Consequently, if for example a hydraulic pump is not available, the remaining components may be assembled into the main shipping assembly 200, and the omitted component can be shipped directly to the final destination. At block 802 any special requirements for ventilation, insulation, or materials based upon code requirements at the installation sight are also identified.

At block 804 the structural frame 250 is assembled. Sound dampers 260 and sound dampers 262 are then installed in the structural frame 250 at block 806. The polymer concrete support assembly 300 is formed and positioned on the sound dampers 260 and sound dampers 262 (block 808). Assembly of the hydraulic plant 350 on the polymer concrete support assembly 300 occurs at block 810 including mounting the first main support face 364 on the polymer concrete support assembly 300 and mounting the remaining components of the hydraulic plant 350 on the main hydraulic manifold 354.

Once the base member 480 and adjustable support plate 500 have been installed on the polymer concrete support assembly 300, the components of the second stage pump 450 and second stage pump 452 selected for installation in the main shipping assembly 200 are installed (block 812). Levelling of the second stage pump 450 and the second stage pump 452 with the screws 492 is typically accomplished during block 812. The second stage pump 450 and second stage pump 452 are placed in hydraulic communication during block 812 and/or during block 810, depending upon the actual timing of the steps.

The electrical component assembly 550 is assembled either directly on the structural frame 250 or separately and then installed as an assembly on the structural frame 250 at block 814. The frame sub-assembly 568 and the frame sub-assembly 570 are assembled on the structural frame 250 or assembled separately and positioned on the structural frame 250 at block 816. At block 818 components of the main shipping assembly 200 which are attached to the frame sub-assembly 568 or the frame sub-assembly 570 are mounted to the frame sub-assembly 568 or the frame sub-assembly 570, and internal wall 600 and internal wall 602 are installed and sealed as desired at block 820. Installation of the wall vent 654, conduit 658 and the conduit 662 is typically accomplished during block 818.

Assembly of the main shipping assembly 200 is completed at block 822 during which the door 700 and panels 716 of the main shipping assembly 200 are installed. The vent 666 and/or the vent 668 can be installed at step 822 if not previously installed. The main shipping assembly 200 is then loaded onto a transport vehicle(s) using the number of pad eyes 252, along with the remaining components of the containerized hydrogen pumping module 150, and transported to the installation site at block 824. Once at the installation site, the main shipping assembly 200 is off-loaded from the transport vehicle(s), again using the number of pad eyes 252, and positioned on a previously identified site (block 826).

Once the main shipping assembly 200 is positioned, the remaining components of the hydrogen compartment 172 which were not incorporated into the main shipping assembly 200 are assembled into the hydrogen compartment 172 including the warm end portion 472 and the warm end portion 476, the cold end portion 458, and the cold end portion 464 (block 828). In some embodiments, the intermediate portion 474 and the intermediate portion 478 are assembled at block 828. The hydrogen compartment cap portion 188 and protective railing assembly 186, along with components supported thereon such as the cooling unit 190 and the blower 664, are then installed to complete assembly of the hydrogen pumping system 100. (Block 830).

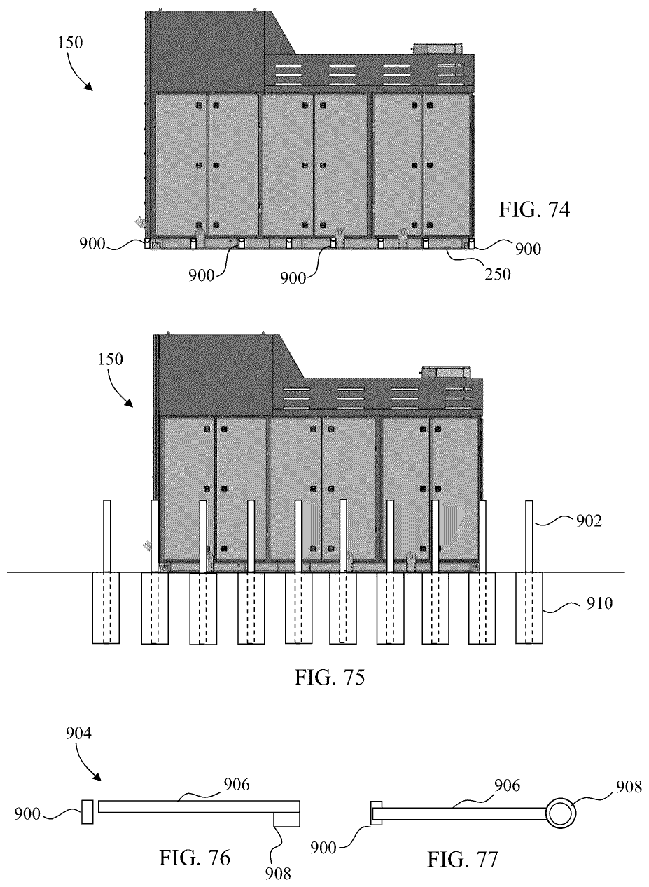

The previously identified site is previously or subsequently prepared and/or configured to satisfy local code requirements (block 832). Typically, local code will require barricades to be provided about the perimeter of the containerized hydrogen pumping module 150 due to the presence of hydrogen. In some embodiments the containerized hydrogen pumping module 150 is configured to aid in assembly of guard posts to protect the containerized hydrogen pumping module 150 from vehicle damage. By way of example, FIG. 74 shows a number of guide brackets 900. The number of guide brackets 900 are spaced about the structural frame 250 so as to assist in the positioning of guard posts 902 shown in FIG. 75.

Typically, a local code will require guard posts to be positioned at a specific distance away from the containerized hydrogen pumping module 150 and with a specific distance between the guard posts 902. Additionally, the guard posts 902 are required to have a minimum diameter, and to be buried in a minimum depth of cement. For example, in some codes the guard post must be at least three feet away from the containerized hydrogen pumping module 150, not more than four feet apart, having a diameter of at least four inches, filled with concrete, set at east three foot deep in a concrete footing of at least 15 inches diameter, and extend at least three foot above ground. To assist in this spacing the number of guide brackets 900 are positioned such that when the guard posts 902 are positioned at least three feet away from the containerized hydrogen pumping module 150, the spacing of the guard posts 902 will not exceed four feet.

The number of guide brackets 900 are used with one or more guides 904 shown in FIG. 76. The one or more guides 904 includes a shaft 906 and a guide ring 908. When the shaft 906 is positioned within one of the number of guide brackets 900 as shown in FIG. 77, the length of the shaft 906 positions the leftmost portion of the ring 908 (as shown in FIG. 77) at least three feet away from the containerized hydrogen pumping module 150. The ring 908 can then be used to mark the location for the footer 910 (see FIG. 75). Once the footer 910 is dug and filed with concrete, the guard posts 902 is positioned within the footer 910 which precisely locates the guard posts 902 within the footer 910. Thus, configuring the hydrogen pumping system 100 is simplified.

In some embodiments the one or more guides 904 is stored within the structural frame 250 during transit. In some embodiments, as allowed by code, the one or more guides 904 is slidingly engaged with the structural frame 250, so as to be deployable once the containerized hydrogen pumping module 150 is positioned. Once deployed, the one or more guides 904 is locked in position, and then fixedly attached to a guard post 902 positioned within the ring 908.

Returning to FIG. 73, at block 834 the containerized hydrogen pumping module 150 is fully incorporated into the hydrogen pumping system 100 such as by connecting the second stage supply header 132 to the ready storage tank 110 and/or the dispensing unit 112, and/or by connecting the supply line 121 to the dispensing unit 113, and/or by connecting the supply line 136 to the bulk storage tank 105, and/or by connecting the supply line 141 to the bulk storage tank 107. Operation of the containerized hydrogen pumping module 150 can then commence once hydrogen is supplied to the hydrogen pumping system 100.

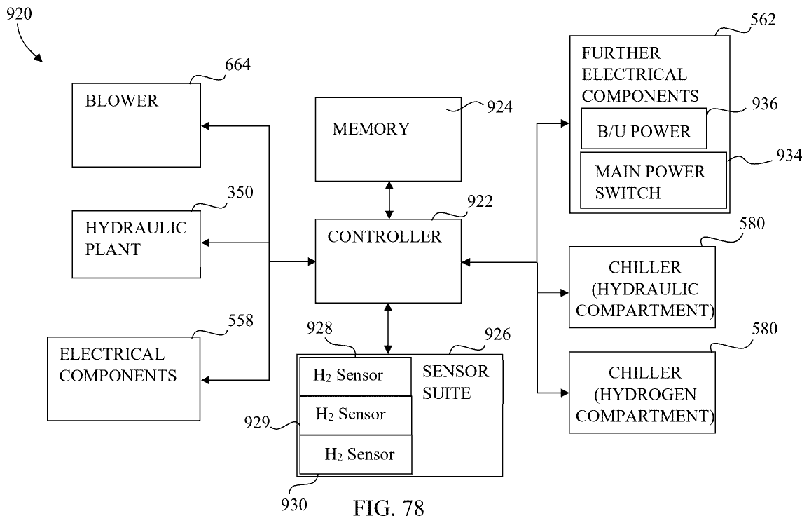

The above-described configuration of the containerized hydrogen pumping module 150 allows for various enhanced operations. Some of the enhanced operations are controlled by a containerized hydrogen pumping module control system 920 shown in FIG. 78.

The containerized hydrogen pumping module control system 920 includes a controller 922 operably connected to a memory 924. Program instructions are stored within the memory 924 and executed by the controller 922 to perform the operations discussed herein, in addition to normal operations of the containerized hydrogen pumping module 150 and, in some embodiments, the hydrogen pumping system 100.

The controller 922 is further operably connected to a sensor suite 926, the blower 664, the hydraulic plant 350, including the various auxiliary system components 400, the various electrical components 558, and the further electrical components 562.

The further electrical components 562 include a main power switch 934, and a backup power supply 936. The controller 922 is further operably connected to the cabinet chiller 580 located in the hydrogen compartment 172 and/or the cabinet chiller 580 located in the hydraulic compartment 168 (see FIG. 55). The sensor suite 926 includes is a first hydrogen sensor 928, a second hydrogen sensor 930, and a third hydrogen sensor 932. The first hydrogen sensor 928 is located within the hydraulic compartment 168 at a location within twelve inches of the ceiling. The second hydrogen sensor 929 is located within the electronics compartment 164 at a location within twelve inches of the ceiling. The third is located within the hydrogen compartment 172 at a location within twelve inches of the ceiling. In different embodiments more or fewer hydrogen sensors are provided. For example, in some embodiments hydrogen sensors are provided at each vent to ensure increased levels of hydrogen are not drawn into the containerized hydrogen pumping module 150.

The number and locations of chillers and heat exchangers will vary based upon heat loads and heat exchange capacities. In the various embodiments the controller 922 controls the chillers and heat exchangers to provide enhanced operations. By way of example, in an embodiment including only the hydrogen-glycol heat exchanger 583, and the chillers 582, the controller 922 controls the chiller 582 in the hydraulic compartment 168 and the chiller 582 in the electronics compartment 164 to use glycol cooled by the hydrogen-glycol heat exchanger 583 to lower temperature and humidity within the electronics compartment 164 and the hydraulic compartment 168. By drying the air within the containerized hydrogen pumping module 150, undesired buildup of ice on piping, especially in the hydrogen compartment 172, is reduced. Advantageously, by using hydrogen within the supply line 111 for this purpose, reduced energy is required to increase the temperature of the hydrogen provided to the dispensing unit 112. Condensation from the various chillers is directed through condensation drains in the polymer concrete support assembly 300 to a location outside of the containerized hydrogen pumping module 150.

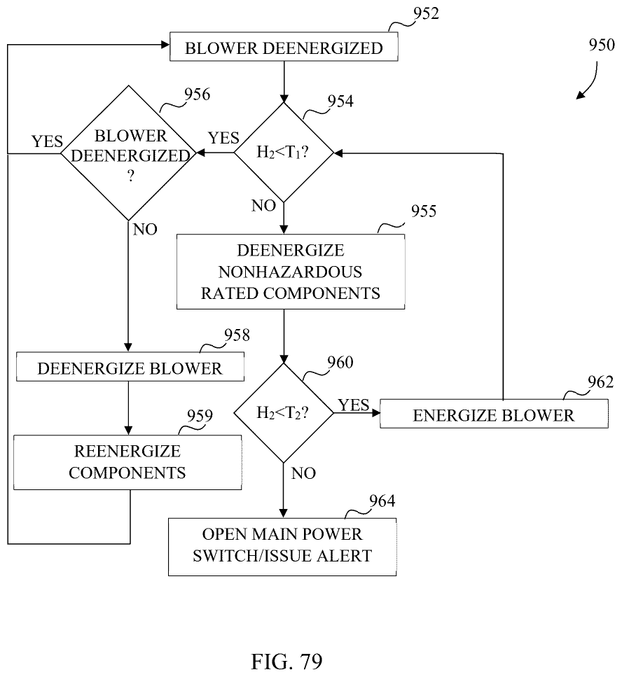

The effectiveness of the chillers 582 is enhanced by maintaining the blower 664 in a de-energized condition. The lack of ventilation within the containerized hydrogen pumping module 150 is allowed under at least some local codes by the provision of the first hydrogen sensor 928 and second hydrogen sensor 930 along with the functionality of the controller 922. In particular, the controller 922 is configured to perform the process 950 shown in FIG. 79.

Initially, the blower 664 is in a deenergized state (block 952). At block 954 the controller 922 queries the first hydrogen sensor 928 and the second hydrogen sensor 930. In embodiments wherein a unique flow path is provided for each of the hydraulic compartment 168 and hydrogen compartment 172, for example wherein separate inlets, such as the vent 666 and vent 668, are provided along with separate outlets, and in some embodiments separate blowers 664, the controller 922 may perform the process 950 separately for each compartment. Thus, the process 950 is performed using the first hydrogen sensor 928 and then separately performed using the second hydrogen sensor 930.

At block 954 if the sensed hydrogen gas is less than a first threshold (T₁), the process continues to block 956 and the controller 922 determines if the blower 664 is deenergized. If the blower 664 is not deenergized at block 956, e.g., previously energized in response to a previously detected level of hydrogen gas above the threshold T₁ as discussed further below, the process continues to block 958 and the blower 664 is deenergized since the hydrogen gas is now less than the first threshold. In some embodiments, the de-energization is delayed until the sensed hydrogen is less than a further threshold which is lower than the first threshold (T₁). The process then continues to block 959 and previously deenergized components (discussed further below) are reenergized. The process continues to block 952 and the controller 922 continues to evaluate the first hydrogen sensor 928 and the second hydrogen sensor 930.

If at block 956 the blower 664 is deenergized, the process continues to block 952 and the controller 922 continues to evaluate the first hydrogen sensor 928 and the second hydrogen sensor 930.

If at block 954 the sensed hydrogen gas is not lower than the first threshold (T₁), the process continues to block 955 and any component in the containerized hydrogen pumping module 150 which is not rated at a desired level is deenergized. In some embodiments, the rating is NEC Class 1 Division 2 Group B. This is done to substantially eliminate potential for components within the containerized hydrogen pumping module 150 to initiate combustion of hydrogen.

The process continues to block 960 and the controller 922 determines if the sensed hydrogen gas is lower than a second threshold (T₂). The threshold T₂ is a threshold which is greater than the threshold T₁, but not higher than a maximum allowed level established by code. In some embodiments the threshold T₂ includes a safety margin such that the threshold T₂ is lower than the maximum allowed level established by code. If the level of detected hydrogen gas is less than the threshold T₂, the process continues to block 962 and the blower 664 is energized. In some embodiments with separate ventilation paths for the hydraulic compartment 168 and hydrogen compartment 172, only the blower associated with the compartment in which the sensor having the high hydrogen level is located is energized. In any event, the blower(s) 664 thus continues to run or is newly energized so as to remove excess hydrogen gas from the hydraulic compartment 168 and/or the hydrogen compartment 172. The process then continues to block 954 and either continues to check the detected levels against the second threshold T₂ at block 960 (for a “NO” at block 954) or proceeds to block 956 (for a YES at block 954) to deenergize the blower 664 at block 958.

If at block 960 the sensed hydrogen gas level is greater than the threshold T₂, then a potentially unsafe condition exists. In some embodiments, the block 960 includes a timer such that if the sensed hydrogen exceeds the threshold T₁ for a predetermined length of time, indicating that the hydrogen concentration is not being sufficiently reduced, a “NO” is returned by the controller logic. Accordingly, at block 964 the controller 922 opens the main power switch 934 to completely deenergize the containerized hydrogen pumping module 150. An alert is also issued to a monitoring site. The process then ends until manual intervention resets the containerized hydrogen pumping module 150 to an operating condition. This ensures that the underlying issue is addressed.

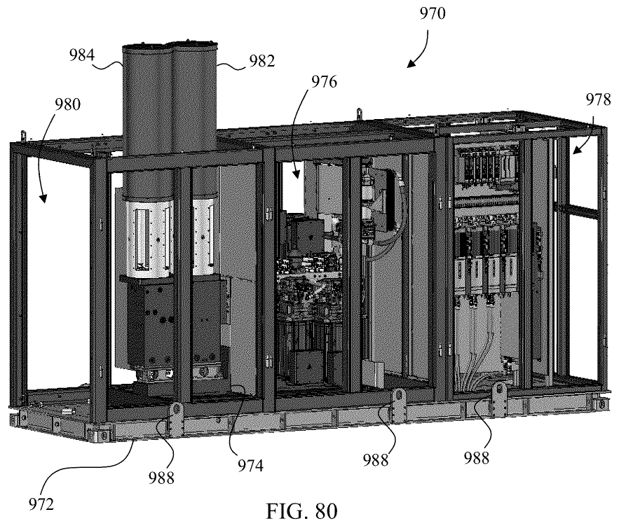

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected. One such modification is discussed with reference to FIG. 80.

FIG. 80 shows a containerized hydrogen pumping module 970 with parts removed to show equipment within the containerized hydrogen pumping module 970. The containerized hydrogen pumping module 970 is formed like the containerized hydrogen pumping module 150, and like components are not discussed in detail.

The containerized hydrogen pumping module 970 includes a structural frame 972, a polymer concrete support assembly 974, a hydraulic plant 976, and an electrical component assembly 978. These components are substantially identical to the components in the containerized hydrogen pumping module 150. The main difference is that the there are no low-pressure pumps located within the hydrogen compartment 980. Rather, two pumps configured as compressor 982 and compressor 984 are provided. Thus, as shown in FIG. 1 the bulk storage tank 104 is directly connected to the compressor 982 and compressor 984 by a supply line 986.

Thus, the same structural components can be used for multiple purposes. Of course, since the hydraulic loading is modified, the electrical components and hydraulic plant 976 are modified to match the different function. Likewise, weight and weight distribution is modified. Thus, the location of pad eyes 988 and structural characteristics of the 972 are modified.

What is claimed is:

1. A containerized hydrogen pumping module, comprising:
a base portion; and
a component portion housing, the component portion housing including an electronics compartment housing, a hydraulic compartment housing, and a hydrogen compartment housing,
wherein
a main shipping assembly includes the base portion, the electronics compartment housing, the hydraulic compartment housing, and at least a portion of the hydrogen compartment housing, and
the main shipping assembly is configured to, in an assembled state, not exceed outer dimensions of a high-cube container.

2. The containerized hydrogen pumping module of claim 1, wherein:
the hydraulic compartment housing includes a main hydrogen compartment housing and a hydrogen compartment cap housing positioned above the main hydrogen compartment housing;
the main shipping assembly includes the main hydrogen compartment housing;
the main shipping assembly does not include the hydrogen compartment cap housing; and
a height of the main hydrogen compartment housing and the hydrogen compartment cap housing is greater than a height of the high-cube container when assembled in the containerized hydrogen pumping module.

3. The containerized hydrogen pumping module of claim 2, wherein:
a hydrogen compartment is defined at least in part by the hydrogen compartment housing;
a hydraulic compartment is defined at least in part by the hydraulic compartment housing; and
a first internal wall is configured to seal the hydrogen compartment from the hydraulic compartment in the assembled state.

4. The containerized hydrogen pumping module of claim 3, wherein:
an electronics compartment is defined at least in part by the electronics compartment housing;
a second internal wall is located between the electronics compartment and the hydraulic compartment;
the hydrogen compartment defines at least in part a first ventilation path between a first external vent and at least one blower;
the hydraulic compartment defines at least in part a second ventilation path between a second external vent and the at least one blower;
the first ventilation path extends from a lower portion of the hydraulic compartment to an upper portion of the hydraulic compartment;
the second ventilation path extends from a lower portion of the hydrogen compartment to an upper portion of the hydrogen compartment; and
the at least one blower is configured to move air along the first ventilation path and along the second ventilation path.

5. The containerized hydrogen pumping module of claim 4, wherein the at least one blower includes:
a first blower configured to move air along the first ventilation path; and
a second blower configured to move air along the second ventilation path.

6. The containerized hydrogen pumping module of claim 3, wherein:
an electronics compartment is defined at least in part by the electronics compartment housing;
a second internal wall is located between the electronics compartment and the hydraulic compartment;
the hydrogen compartment and the hydraulic compartment define at least in part a ventilation path;
the ventilation path extends from a lower portion of the hydraulic compartment to an upper portion of the hydraulic compartment;
the ventilation path extends from the upper portion of the hydraulic compartment through the first internal wall to a lower portion of the hydrogen compartment;
the ventilation path extends from the lower portion of the hydrogen compartment to an upper portion of the hydrogen compartment; and
a blower is configured to move air along the ventilation path.

7. The containerized hydrogen pumping module of claim 6, further comprising:
a first hydrogen sensor positioned in the upper portion of the hydraulic compartment;
a second hydrogen sensor positioned at the upper portion of the hydrogen compartment;
a main power switch through which all electrical power to the containerized hydrogen pumping module is provided;
a memory having program instructions stored therein; and
a controller operably connected to the first hydrogen sensor, the second hydrogen sensor, the main power switch, and the memory, the controller configured to execute the program instructions to open the main power switch in response to a hydrogen level, detected by the first hydrogen sensor or the second hydrogen sensor, which exceeds a predetermined threshold.

8. The containerized hydrogen pumping module of claim 7, further comprising:
a backup power supply, the backup power supply configured to power the blower when the controller opens the main power switch in response to the hydrogen level which exceeds the predetermined threshold.

9. The containerized hydrogen pumping module of claim 1, wherein the base portion comprises:
a base support component; and
a polymer concrete support structure supported by the base support component.

10. The containerized hydrogen pumping module of claim 9, further comprising:
a plurality of sound isolation components, wherein the polymer concrete support structure is supported on the base support component by the plurality of sound isolation components.

11. The containerized hydrogen pumping module of claim 10, further comprising:
a hydraulic support assembly mounted on the polymer concrete support structure and extending upwardly within a hydraulic compartment defined at least in part by the hydraulic compartment housing;
a main hydraulic system manifold mounted on an upper surface of the hydraulic support assembly; and
a hydraulic supply system fluidically connected to at least one low-pressure pump of a low-pressure pump system, and at least one second stage pump of a second stage pump system, wherein the hydraulic supply system is supported within the hydraulic compartment solely through the main hydraulic system manifold.

12. The containerized hydrogen pumping module of claim 11, further comprising:
a second stage support assembly mounted on the polymer concrete support structure and extending upwardly within a hydrogen compartment defined at least in part by the hydrogen compartment housing,
wherein
the second stage pump system is supported within the hydrogen compartment solely through the second stage support assembly.

13. The containerized hydrogen pumping module of claim 12, wherein the second stage support assembly comprises:
a base member fixedly mounted on the polymer concrete support structure;
an adjustable support plate mounted on the base member with a plurality of adjusting bolts, the plurality of adjusting bolts configured to modify an orientation of the adjustable support plate with the base member,
wherein,
the second stage pump system is supported by the base member through the adjustable support plate.

14. The containerized hydrogen pumping module of claim 13, further comprising:
a first internal wall configured to seal the hydrogen compartment from the hydraulic compartment in the assembled state,
wherein
the main hydraulic system manifold extends through the first internal wall to the hydrogen compartment, and
all hydraulics to the hydrogen compartment are supplied through the main hydraulic system manifold.
